(19) United States
(12) Patent Application Publication
(10) Pub. No.: US 2017/0114233 A1
(43) Pub. Date: Apr. 27, 2017

(54) ACTIVE ENERGY RAY CURABLE COMPOSITION, STEREOSCOPIC MODELING MATERIAL, ACTIVE ENERGY RAY CURABLE INK, INKJET INK, COMPOSITION STORAGE CONTAINER, TWO-DIMENSIONAL OR THREE-DIMENSIONAL IMAGE FORMING APPARATUS, TWO-DIMENSIONAL OR THREE-DIMENSIONAL IMAGE FORMING METHOD, STRUCTURAL BODY, AND PROCESSED PRODUCT

(71) Applicants: Tsuyoshi ASAMI, Kanagawa (JP); Tomohiro Hirade, Kanagawa (JP)

(72) Inventors: Tsuyoshi ASAMI, Kanagawa (JP); Tomohiro Hirade, Kanagawa (JP)

(21) Appl. No.: 15/280,610

(22) Filed: Sep. 29, 2016

(30) Foreign Application Priority Data
Oct. 26, 2015 (JP) 2015-209560

(51) Int. Cl. C09D 11/03; B41J 2/01; C09D 11/322; C08K 3/22; C09D 11/101

(52) U.S. Cl. CPC C09D 11/03; C08K 3/22; C09D 11/101; C09D 11/322; B41J 2/01; C08K 2003/2241

(57) ABSTRACT

An active energy ray curable composition is provided. The active energy ray curable composition includes a pigment including a titanium oxide, a dispersant, and a polymerizable compound. At least a part of the dispersant is adsorbed to the pigment at an adsorption rate of from 5 to 80 mg per 1 g of the pigment.

### CROSS-REFERENCE TO RELATED APPLICATIONS

This patent application is based on and claims priority pursuant to 35 U.S.C. §119(a) to Japanese Patent Application No. 2015-209560, filed on Oct. 26, 2015, in the Japan Patent Office, the entire disclosure of which is hereby incorporated by reference herein.

### BACKGROUND

Technical Field

The present disclosure relates to an active energy ray curable composition, a stereoscopic modeling material, an active energy ray curable ink, an inkjet ink, a composition storage container, a two-dimensional or three-dimensional image forming apparatus, a two-dimensional or three-dimensional image forming method, a structural body, and a processed product.

Description of the Related Art

Active energy ray curable inks generally have less odor and higher quick-drying property than solvent inks and are preferably used for ink-unabsorbale recoding media.

An active energy ray curable ink generally includes a monomer and several types of polymerization initiators having different absorption wavelengths selected in accordance with the type of light source (e.g., mercury lamp, metal halide lamp) in use. The active energy ray curable ink cures as the monomer molecules are bonded together by the action of the polymerization initiators.

Nowadays, in terms of energy saving, ultraviolet light-emitting diodes having a peak light-emitting wavelength of 365 nm or 385 nm are widely used, since they consume a less amount of power.

Generally, active energy ray curable inks have the properties of: being effectively curable by exposure to light having the above-described peak light-emitting wavelength; being formed into a high-density image when cured: being reliably dischargeable from heads; and keeping ink properties in good condition even when stored.

When a pigment is not well dispersible in the monomer (i.e., dispersing medium) in the active energy ray curable ink, the ink is not able to produce an image with a desired color density. Moreover, when the pigment has too large a particle diameter, the viscosity of the ink becomes so high that the property of being dischargeable from heads will disadvantageously decrease.

To make the pigment be dispersible in the monomer while having a particle diameter approximately equal to the primary particle diameter thereof, the pigment is required to have an affinity for the monomer and not to aggregate by the occurrence of steric hindrance or charge repulsion. In view of this situation, there have been attempts to: (1) include a dispersant having a pigment-adsorptive site and a monomer-compatible site in the ink; (2) capsulate the pigment with a highly-monomer-compatible material; and (3) modify the pigment to be self-dispersible.

### SUMMARY

In accordance with some embodiments of the present invention, an active energy ray curable composition is provided. The active energy ray curable composition includes a pigment including a titanium oxide, a dispersant, and a polymerizable compound. At least a part of the dispersant is adsorbed to the pigment at an adsorption rate of from 5 to 80 mg per 1 g of the pigment.

In accordance with some embodiments of the present invention, a stereoscopic modeling material is provided. The stereoscopic modeling material include the above active energy ray curable composition.

In accordance with some embodiments of the present invention, an active energy ray curable ink is provided. The active energy ray curable ink includes the above active energy ray curable composition.

In accordance with some embodiments of the present invention, an inkjet ink is provided. The inkjet ink includes the above active energy ray curable ink.

In accordance with some embodiments of the present invention, a composition storage container is provided. The composition storage container includes a container and the above active energy ray curable composition contained in the container.

In accordance with some embodiments of the present invention, a two-dimensional or three-dimensional image forming apparatus is provided. The two-dimensional or three-dimensional image forming apparatus includes an emitter and a storage. The emitter emits an active energy ray to the above active energy ray curable composition. The storage stores the active energy ray curable composition.

In accordance with some embodiments of the present invention, a two-dimensional or three-dimensional image forming method is provided. The two-dimensional or three-dimensional image forming method includes a process of emitting an active energy ray to the above active energy ray curable composition to cause the active energy ray composition to cure.

In accordance with some embodiments of the present invention, a two-dimensional or three-dimensional image is provided. The two-dimensional or three-dimensional image is produced by emitting an active energy ray to the above active energy ray curable composition to cause the active energy ray composition to cure.

In accordance with some embodiments of the present invention, a structural body is provided. The structural body includes a substrate and the above two-dimensional or three-dimensional image on the substrate.

In accordance with some embodiments of the present invention, a processed product is provided. The processed product is produced by stretching-processing the above structural body.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an example of an ultraviolet spectrum radiated by a mercury lamp;

FIG. 2 is an example of an ultraviolet spectrum radiated by a metal halide lamp;

FIG. 3 is an example of an ultraviolet spectrum radiated by an UV-LED lamp:

FIG. 4 is a schematic view of an image forming apparatus according to an embodiment of the present invention;

FIGS. 5A to 5D are schematic views of an image forming apparatus according to an embodiment of the present invention; and

FIG. 6 is a schematic view of an image forming apparatus according to an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

In accordance with some embodiments of the present invention, an active energy ray curable composition having a good combination of dispersibility, dischargeability, hiding power, curability, and filterability is provided.

### Active Energy Ray Curable Composition

The active energy ray curable composition according to an embodiment of the present invention includes a pigment, a dispersant, and a polymerizable compound. The active energy ray curable composition may optionally include other components, such as a polymerization initiator and a polymerization accelerator, if necessary.

The pigment includes a titanium oxide that has a high hiding power. An adsorbed component is adsorbed to the pigment at an adsorption rate of from 5 to 80 mg per 1 g of the pigment, thus making the pigment well dispersible and the dispersant effectively adsorptive to the pigment. Therefore, the active energy ray curable composition is given a good combination of dischargeability, filterability, hiding power, curability, and adhesion property. Hereinafter, the absorption rate of an adsorbed component to 1 g of the pigment may be expressed with a unit “mg/g”.

When the adsorption rate is less than 5 mg/g, the pigment cannot keep compatibility with the dispersing medium, resulting in deterioration of pigment dispersibility. When the adsorption rate is in excess of 80 mg/g, the dispersion liquid (active energy ray curable composition) itself becomes so viscous that the curability, adhesion property, and strength of the cured film thereof deteriorate. In addition, filterability deteriorates, in particular, in a process of removing coarse particles with a filter with an opening of 1 μm or less, resulting in deterioration of productivity.

Preferably, the absorbed component is the dispersant. More preferably, a first amount of the dispersant is adsorbed to the pigment at an absorption rate of from 10 to 30 mg per 1 g of the pigment.

Preferably, a second amount of the dispersant is not adsorbed to the pigment, and the second amount ranges from 10% to 50% of the first amount. A certain amount of the dispersant remains not adsorbed to the pigment, so as to keep a balance between those adsorbed to the pigment and those not adsorbed to the pigment.

When the second amount of the dispersant not adsorbed to the pigment is less than 10% of the first amount of the dispersant adsorbed to the pigment, the dispersant adsorbed to the pigment easily transfers to the dispersing medium, thereby reducing the amount of dispersant adsorbed to the pigment.

When the second amount of the dispersant not adsorbed to the pigment is in excess of 50% of the first amount of the dispersant adsorbed to the pigment, various adverse effects are caused, such as viscosity rise and deterioration of filterability, curability, and adhesion property of the dispersion liquid (active energy ray curable composition), while no effect of balancing the dispersant adsorbed to the pigment and that not adsorbed to the pigment is provided.

Preferably, after the active energy ray curable composition has been stored at 70° C. for two weeks, a third amount of the dispersant is adsorbed to the pigment, and the third amount ranges from 80% to 120% of the first amount. If the dispersant is adsorbed to the pigment with a weak adsorption force, the dispersant will release from the pigment and the pigment dispersibility will deteriorate after the active energy ray curable composition has been stored at 70° C. for two weeks.

When the ratio of the third amount to the first amount is less than 80%, it means that the adsorption force is so weak that the pigment dispersion state is unstable. When the ratio of the third amount to the first amount is in excess of 120%, it means that the dispersion liquid (active energy ray curable composition) will undergo a large viscosity change, which is not preferable.

The amount of the dispersant adsorbed to the pigment can be measured in the following manner. First, 1.5 g of a sample (e.g., ink) is weighed in a 1-ml sample holder used for centrifugal separation. The sample is subject to a centrifugal separation at a revolution of 10,000 rpm for 1 hour, and the resulting supernatant is removed thereafter. The same amount of acetone as the removed supernatant is added to the holder. The holder contents are stirred with a spatula and subject to the centrifugal separation four times, followed by a complete drying by a vacuum drier.

About 100 mg of the dried sample is precisely weighed in an aluminum cup and heated at 400° C. for 2 hours. After the heating, the residual amount of the sample is measured.

Amount of Dispersant Adsorbed to 1 g of Pigment=1,000 (mg)/Residual Amount after Heating (mg)×Decreased Amount after Heating (mg)

The amount of the dispersant not adsorbed to the pigment is calculated by the following formula:

(Blending Amount of Dispersant/Blending Amount of Pigment)×1,000 (mg)−Amount of Dispersant Adsorbed to 1 g of Pigment (mg)

When the blending amounts are unknown, the amount of the dispersant not adsorbed to the pigment can be calculated by, for example, analyzing the above-obtained supernatant by liquid chromatography.

Preferably, the active energy ray curable composition has a volume average particle diameter of from 230 to 300 nm, more preferably from 240 to 280 nm. When the volume average particle diameter is 230 nm or more, hiding power and print density are improved. When the volume average particle diameter is 300 nm or less, it is easy to increase hiding power. In addition, when applied to inkjet systems, the active energy ray curable composition is suppressed from clogging heads and reliably dischargeable from the heads. The volume average particle diameter of the active energy ray curable composition can be measured by diluting the active energy ray curable composition to about 100 times with phenoxyethyl acrylate and subjecting the dilution to a measurement with a particle size analyzer (UPA150 available from Nikkiso Co., Ltd.). The volume average particle diameter of the active energy ray curable composition is defined as the volume average particle diameter obtained by subjecting the active energy ray curable composition itself to a measurement, which corresponds to a particle diameter of a particulate body (i.e., a pigment dispersion containing the pigment) included in the active energy ray curable composition.

When the active energy ray curable composition is put on a transparent substrate and irradiated with an active energy ray having an illuminance of 1 W/cm² at an irradiation dose of 500 mJ/cm² to become a cured product (image) film having an average thickness of 10 μm, the cured product preferably exhibits a contrast ratio of 81% or greater, more preferably 84% or greater, most preferably from 90% to 100%, relative to black color.

The average thickness can be measured by subjecting 10 randomly selected portions of the film to a measurement by a contact-type (pointer-type) or eddy-current-type film thickness meter (e.g., an electronic micrometer available from Anritsu Corporation) and averaging the 10 measured values.

To measure the contrast ratio, first, the cured product is subject to a measurement of a density relative to black color by a reflective spectrodensitometer (X-Rite 939 available from X-Rite) with a black paper sheet (EXTRA BLACK available from Takeo Co., Ltd.) put on the other side of the transparent substrate opposite to the side having the cured product thereon. The contrast ratio is calculated from the following formula (1).

Contrast Ratio (%)=[1−(Density of Cured Product/Density of Black Paper Sheet (1.65))]×100 Formula (1)

Preferably, 10% by volume or less of the active energy ray curable composition has a particle diameter of 170 nm or less.

Preferably, another 10% by volume or less of the active energy ray curable composition has a particle diameter of 380 nm or more.

Preferably, the active energy ray curable composition is sensitive to light-emitting diode light having a light-emitting peak within a wavelength range of from 360 to 400 nm. Here, being sensitive to light-emitting diode light refers to having a property of being polymerizable and curable by irradiation with the light-emitting diode light either in the presence of or absence of a polymerization initiator.

Preferably, the pigment has a number average primary particle diameter of from 220 to 260 nm, more preferably from 230 to 250 nm. When the number average primary particle diameter is from 220 to 260 nm, it is easy to increase the contrast ratio to 84% or greater, thus improving the dispersibility.

The number average primary particle diameter can be measured by observing the pigment with a scanning electron microscope (SU3500 available from Hitachi High-Technologies Corporation) at a magnification of 10,000 times, measuring the unidirectional particle diameter of each of 200 to 500 primary particles existing between a pair of parallel lines, and averaging the measured unidirectional particle diameters.

Preferably, a ratio (Dv/Dn) of the volume average particle diameter (Dv) of the active energy ray curable composition and the number average primary particle diameter (Dn) of the pigment ranges from 1 to 1.2, more preferably from 1 to 1.1.

The pigment may further include a white inorganic pigment in combination with the titanium oxide.

Specific examples of usable white inorganic pigments include, but are not limited to, alkaline-earth metal sulfates (e.g., barium sulfate), alkaline-earth metal carbonates (e.g., calcium carbonate), fine powders of silicic acid, silicas (e.g., synthetic silicate), calcium silicates, aluminas, alumina hydrates, zinc oxides, talc, and clay.

Preferably, the titanium oxide accounts for 70% by mass or more of the pigment.

The titanium oxide may take a crystal structure, such as an anatase structure and a rutile structure. Rutile structure is more preferable because its optical catalytic activity is low.

Preferably, the pigment has been surface-treated. More preferably, the pigment has been surface-treated to have hydrophilicity. When the pigment surface has hydrophilicity, the pigment dispersibility is improved and the curability is improved.

Specific examples of usable surface treatment agents include, but are not limited to, Al₂O₃, SiO₂, and ZrO₂. From the aspect of dispersibility, Al₂O₃ is most preferable. In addition to the above-described function of improving pigment dispersibility, SiO₂ and ZrO₂ each have another function of preventing titanium oxide from exhibiting optical catalytic activity, thereby improving light resistance of the resulting cured film.

Specific examples of the surface treatment method include, but are not limited to, a pigment derivative treatment, a resin modification, an oxidization treatment, and a plasma treatment.

Specific examples of the titanium oxide include, but are not limited to, the following commercially-available products: TCR-52 (having a number average primary particle diameter of 230 nm, surface-treated with Al₂O₃, available from Sakai Chemical Industry Co., Ltd.), S3618 (having a number average primary particle diameter of 230 nm, surface-treated with Al₂O₃, available from Sakai Chemical Industry Co., Ltd.), JR403 (having a number average primary particle diameter of 250 nm, surface-treated with Al₂O₃ and SiO₂, available from Tayca Corporation), JR (having a number average primary particle diameter of 270 nm, no surface treatment, available from Tayca Corporation), JR301 (having a number average primary particle diameter of 300 nm, surface-treated with Al₂O₃, available from Tayca Corporation), and R45M (having a number average primary particle diameter of 290 nm, surface-treated with Al₂O₃ and SiO₂, available from Sakai Chemical Industry Co., Ltd.). Each of these products can be used alone or in combination with others.

Specific preferred examples of the titanium oxide include, but are not limited to, titanium oxides disclosed in JP-2012-214534-A and JP-2014-185235-A.

However, a mere use of titanium oxides disclosed in JP-2012-214534-A and JP-2014-185235-A may not achieve the desired adsorption amount of the dispersant, unless the types of materials used in combination, blending amount, and production process are optimized. In particular, the adsorption amount of the dispersant can be adjusted by controlling the particle diameter, surface treatment process, and dispersing method of the titanium oxide and the types of functional groups in the dispersant. For example, as the particle diameter of a titanium oxide gets smaller and the surface treatment amount of the titanium oxide with an alumina gets larger, it is likely that the adsorption amount of the dispersant gets larger. In addition, as the polarity (basicity or acidity) of the functional group in the dispersant gets stronger, it is likely that the adsorption amount of the dispersant gets larger. With respect to the dispersing process, the dispersant is more strongly adsorbed to the pigment when the dispersing is performed while changing the pigment density to a high level to a predetermined lower level by dilution than a case in which the dispersing is performed at a constant pigment density.

The titanium oxide may be a mixture of two or more types of titanium oxides so long as the above-described adsorption amount is maintained.

Preferably, the pigment is included in the active energy ray curable composition in the form of a pigment dispersion.

Preferably, the content rate of the pigment in the active energy ray curable composition ranges from 10% to 20% by mass. When the content rate is 10% by mass or more, hiding power is improved. When the content rate is 20% by mass or less, viscosity rise is suppressed and dischargeability is improved.

### Polymerizable Compound

Specific examples of the polymerizable compound include, but are not limited to, polymerizable unsaturated monomer compounds and polymerizable oligomers.

### Polymerizable Unsaturated Monomer Compound

Specific examples of the polymerizable unsaturated monomer compounds include, but are not limited to, monofunctional polymerizable unsaturated monomer compounds, difunctional polymerizable unsaturated monomer compounds, trifunctional polymerizable unsaturated monomer compounds, and tetrafunctional polymerizable unsaturated monomer compounds. Each of these compounds can be used alone or in combination with others.

Specific examples of the monofunctional polymerizable unsaturated monomer compounds include, but are not limited to, 2-ethylhexyl acrylate, 2-hydroxyethyl acrylate, 2-hydroxymethyl acrylate, 2-hydroxypropyl acrylate, benzyl acrylate, phenoxyethyl acrylate, isobornyl acrylate, phenyl glycol monoacrylate, cyclohexyl acrylate, acryloyl morpholine, tetrahydrofurfuryl acrylate, 4-hydroxybutyl acrylate, and 2-methyl-2-ethyl-1,3-dioxolan-4-ylmethyl acrylate. Each of these compounds can be used alone or in combination with others.

Specific examples of the difunctional polymerizable unsaturated monomer compounds include, but are not limited to, 1,4-butanediol diacrylate, 1,6-hexanediol diacrylate, 1,9-nonanediol diacrylate, tripropylene glycol diacrylate, tetraethylene glycol diacrylate, and dimethylol tricyclodecane diacrylate. Each of these compounds can be used alone or in combination with others.

Specific examples of the trifunctional polymerizable unsaturated monomer compounds include, but are not limited to, trimethylolpropane triacrylate, pentaerythritol triacrylate, and tris(2-hydroxyethyl) isocyanurate triacrylate. Each of these compounds can be used alone or in combination with others.

Specific examples of the tetrafunctional polymerizable unsaturated monomer compounds include, but are not limited to, pentaerythritol tetraacrylate, ditrimethylolpropane tetraacrylate, dipentaerythritol hydroxypentaacrylate, dipentaerythritol pentaacrylate, and dipentaerythritol hexaacrylate. Each of these compounds can be used alone or in combination with others.

Each of the above polymerizable unsaturated monomer compounds can be used alone or in combination with others of different types.

The monofunctional polymerizable unsaturated monomer compounds are capable of more increasing the curing speed compared to the polyfunctional polymerizable unsaturated monomer compounds. However, the monofunctional polymerizable unsaturated monomer compounds may increase the viscosity of the composition or cause a large volume contraction. Therefore, polymerizable unsaturated monomer compounds which can lower the viscosity are preferable.

Preferably, an image formed by curing the active energy ray composition including the above-described polymerizable unsaturated monomer compound exhibits a volume contraction rate of 15% by volume or less, more preferably 8% by volume or less.

Preferably, the polymerizable unsaturated monomer compound has a skin irritation index (Primary Irritation Index (P.I.I.)) of 1.0 or less. When the skin irritation index is 1.0 or less, skin irritation is reduced and safety is improved.

With respect to color hue, preferably, the polymerizable unsaturated monomer compound has a Gardner gray scale of 2 or less. More preferably, the polymerizable unsaturated monomer compound is colorless and transparent. When the Gardner gray scale is 2 or less, the resulting image is prevented from undergoing a color change. The Gardner gray scale can be measured by a testing method according to JIS-0071-2 (“Testing methods for colour of chemical products—Part 2: Gardner colour scale”).

The content rate of the polymerizable unsaturated monomer compound in the active energy ray curable composition is preferably in the range of from 55% to 85% by mass, more preferably from 65% to 75% by mass.

### Polymerizable Oligomer

The polymerizable oligomer preferably includes at least one ethylenic unsaturated double bond. Here, an oligomer is defined as a polymer having from 2 to 20 repeating monomer structural units.

The polymerizable oligomer preferably has a polystyrene-conversion weight average molecular weight of from 1,000 to 30,000, more preferably from 5,000 to 20,000. The weight average molecular weight can be measured by a gel permeation chromatographic (GPC) apparatus.

Specific examples of the polymerizable oligomer include, but are not limited to, urethane acrylic oligomers (e.g., aromatic urethane acrylic oligomers, aliphatic urethane acrylic oligomers), epoxy acrylate oligomers, polyester acrylate oligomers, and special oligomers. Each of these compounds can be used alone or in combination with others. Among these compounds, oligomers having 2 to 5 unsaturated carbon-carbon bonds are preferable, and oligomers having 2 unsaturated carbon-carbon bonds are more preferable. When the number of unsaturated carbon-carbon bonds is in the range of from 2 to 5, good curability is provided.

Specific examples of the polymerizable oligomer include, but are not limited to, the following commercially-available products: UV-2000B, UV-2750B, UV-3000B, UV-3010B, UV-3200B, UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 (available from The Nippon Synthetic Chemical Industry Co., Ltd.); CN902, CN902J75, CN929, CN940, CN944, CN944B85, CN961E75, CN961H81, CN962, CN963, CN963A80, CN963B80, CN963E75, CN963E80, CN963J85, CN964, CN965, CN965A80, CN966A80, CN966B85, CN966H90, CN966J75, CN968, CN969, CN970, CN970A60, CN970E60, CN971, CN971A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 (products of Sartomer); and EBECRYL 210, EBECRYL 220, EBECRYL 230, EBECRYL 270, KRM 8200, EBECRYL 5129, EBECRYL 8210, EBECRYL 8301, EBECRYL 8804, EBECRYL 8807, EBECRYL 9260, KRM 7735, KRM 8296, KRM 8452, EBECRYL 4858, EBECRYL 8402, EBECRYL 9270, EBECRYL 8311, and EBECRYL 8701 (available from DAICEL-ALLNEX LTD.). Each of these compounds can be used alone or in combination with others.

In addition to the above commercial products, synthetic products can also be used as the polymerizable oligomer. Commercial products and synthetic products can be used in combination.

Preferably, the polymerizable oligomer has a skin irritation index (Primary Irritation Index (P.I.I.)) of 1.0 or less. When the skin irritation index is 1.0 or less, skin irritation is reduced and safety is improved.

With respect to color hue, preferably, the polymerizable oligomer has a Gardner gray scale of 2 or less. More preferably, the polymerizable oligomer is colorless and transparent. When the Gardner gray scale is 2 or less, the resulting image is prevented from undergoing a color change. The Gardner gray scale can be measured by a testing method according to JIS-0071-2 (“Testing methods for colour of chemical products—Part 2: Gardner colour scale”).

The content rate of the polymerizable oligomer in the active energy ray curable composition is preferably 10% by mass or less, more preferably 9% by mass or less, much more preferably 8% by mass or less, and most preferably 5% by mass or less. When the content rate is 10% by mass or less, the cured product exhibits a high hardness.

### Dispersant

The dispersant is included in the active energy ray curable composition for dispersing the pigment.

Preferably, the dispersant has an acid value of 5 mgKOH/g or greater, more preferably 15 mgKOH/g or greater.

Preferably, the dispersant has an amine value of 15 mgKOH/g or greater, more preferably 25 mgKOH/g or greater.

Preferably, the dispersant is a polymeric dispersant.

Specific examples of the polymeric dispersant include, but are not limited to, polyoxyalkylene polyalkylene polyamine, vinyl polymer and copolymer, acrylic polymer and copolymer, polyester, polyamide, polyimide, polyurethane, and amino polymer. Each of these compounds can be used alone or in combination with others. Among these compounds, acrylic polymer and copolymer are preferable. From the aspect of pigment adsorptivity, an acrylic block copolymer having an acid value of 5 mgKOH/g or more and an amine value of 15 mgKOH/g or more is preferable.

Specific examples of the polymeric dispersant further include, but are not limited to, the following commercially-available products: AJISPER series available from Ajinomoto Fine-Techno Co., Inc.; SOLSPERSE series available from The Lubrizol Corporation (Avecia, Noveon), such as SOLSPERSE 32000 (having an acid value of 15.5 mgKOH/g and an amine value of 31.2 mgKOH/g) and SOLSPERSE 39000 (having an acid value of 33 mgKOH/g and amine value of 0 mgKOH/g); DISPERBYK series, such as DISPERBYK-168 (having an acid value of 0 mgKOH/g and amine value of 11 mgKOH/g) and DISPERBYK-167 (having an acid value of 0 mgKOH/g and amine value of 13 mgKOH/g), and BYKJET series, both available from BYK Japan KK; and DISPARLON series available from Kusumoto Chemicals, Ltd. Each of these compounds can be used alone or in combination with others.

The acrylic block copolymer may also be a commercial product, such as BYKJET-9151 (having an acid value of 8 mgKOH/g and an amine value of 18 mgKOH/g) available from BYK Japan KK.

When the absorption rate is within the above-described specified range, the dispersant is capable of covering the pigment in just proportion, thus preventing the pigment from aggregating while improving the pigment dispersibility. Moreover, since there is no excessive dispersant which may be eluted off to increase the viscosity of the composition, dischargeability of the composition is improved. The content rate of the dispersant in the active energy ray curable composition is not particularly limited so long as the absorption rate is within the specified range, but is preferably in the range of from 0.1% to 1.5% by mass, more preferably from 0.3% to 1.0% by mass.

### Active Energy Ray

Specific examples of the active energy ray for causing the active energy ray curable composition to cure include, but are not limited to, ultraviolet ray, electron beam, α-ray, β-ray, γ-ray, and X-ray, which are capable of giving energy to polymerizable compounds included in the active energy ray curable composition to cause a polymerization reaction. When the active energy ray is emitted from a high-energy light source, the polymerizable compound can undergo a polymerization reaction without using a polymerization initiator. In the case of ultraviolet ray emission, a GaN-based semiconductor ultraviolet light emitting device is preferably used as the light source from both industrial and environmental aspects. In particular, use of mercury-free light sources is strongly demanded in accordance with an increasing momentum of environment preservation. In addition, ultraviolet light emitting diode (UV-LED) and ultraviolet light laser diode (UV-LD) are preferable since they are advantageous in terms of their compact size, extended lifespan, high efficiency, and low cost.

### Polymerization Initiator

The active energy ray curable composition according to an embodiment of the present invention may include a polymerization initiator. The polymerization initiator is capable of generating active species, such as radical and cation, by the action of the active energy ray, to cause the polymerizable compounds (e.g., monomer, oligomer) included in the active energy ray curable composition to initiate a polymerization. Examples of the polymerization initiator include radical polymerization initiators, cationic polymerization initiators, base generators, and combinations thereof. In particular, radical polymerization initiators are preferable. In order to secure a sufficient curing speed, the content rate of the polymerization initiator is preferably in the range of from 5% to 20% by mass based on total mass (100% by mass) of the composition.

Specific examples of the radical polymerization initiators include, but are not limited to, aromatic ketones, acylphosphine oxide compounds, aromatic onium salt compounds, organic peroxides, thio compounds (e.g., thioxanthone compounds, thiophenyl-group-containing compounds), hexaaryl biimidazole compounds, ketoxime ester compounds, borate compounds, azinium compounds, metallocene compounds, active ester compounds, carbon-halogen-bond-containing compounds, and alkylamine compounds.

The polymerization initiator can be used in combination with a polymerization accelerator (sensitizer). Specific examples of the polymerization accelerator include, but are not limited to, amine compounds, such as trimethylamine, methyldimethanolamine, triethanolamine, p-diethylaminoacetophenone, p-dimethylaminobenzoate, 2-ethylhexyl p-dimethylaminobenzoate, N,N-dimethylbenzylamine, and 4,4′-bis(diethylamino)benzophenone. The content of the polymerization accelerator is determined depending on the type and amount of the polymerization initiator used in combination.

Preferably, a suitable polymerization initiator is selected in accordance with the wavelength property of an irradiation lamp (e.g., mercury lamp, metal halide lamp, UV-LED lamp) in use. In particular, thio compounds are preferable, and thioxanthone compounds (thioxanthone polymerization initiators) are more preferable, since they are unlikely to be affected by oxygen inhibition when a thin cured film is formed.

Specific examples of the polymerization initiator include, but are not limited to, the following commercially-available products: IRGACURE 819, IRGACURE 369, and IRGACURE 907 available from BASF; DarocurlTX; LUCIRIN TPO; and VICURE 10 and 30 available from Stauffer Chemical Company. Each of these compounds can be used alone or in combination with others.

Specific examples of the thioxanthone polymerization initiator include, but are not limited to, the following commercially-available products: Speedcure DETX (2,4-diethylthioxanthone) and Speedcure ITX (2-isopropylthioxanthone) available from Lambson Limited; and KAYACURE DETX-S (2,4-diethylthioxanthone) available from Nippon Kayaku Co., Ltd.

Preferably, the polymerization initiator: (i) has a high active energy ray absorption efficiency; (ii) has a high solubility in the polymerizable unsaturated monomer compound; (iii) has low levels of odor, xanthosis, and toxicity; and (iv) is unlikely to cause a dark reaction.

The polymerization initiator can be used in combination with a polymerization accelerator.

Specific examples of the polymerization accelerator include, but are not limited to, amine compounds, such as ethyl p-dimethylaminobenzoate, 2-ethylhexyl p-dimethylaminobenzoate, methyl p-dimethylaminobenzoate, 2-dimethylaminoethyl benzoate, and butoxyethyl p-dimethylaminobenzoate. Each of these compounds can be used alone or in combination with others.

When a mixture of the polymerizable unsaturated monomer compound and the polymerization initiator is irradiated with an active energy ray (ultraviolet ray), the polymerization initiator generates radicals as described in the following formulae (I) and (II). The radicals cause addition reactions to the polymerizable double bonds of the polymerizable unsaturated monomer compound or the polymerizable oligomer. Further radicals are generated in the addition reactions and cause addition reactions to the polymerizable double bonds of the polymerizable unsaturated monomer compound or the polymerizable oligomer. This process repeatedly occurs to progress a polymerization reaction described in the following formula (III).

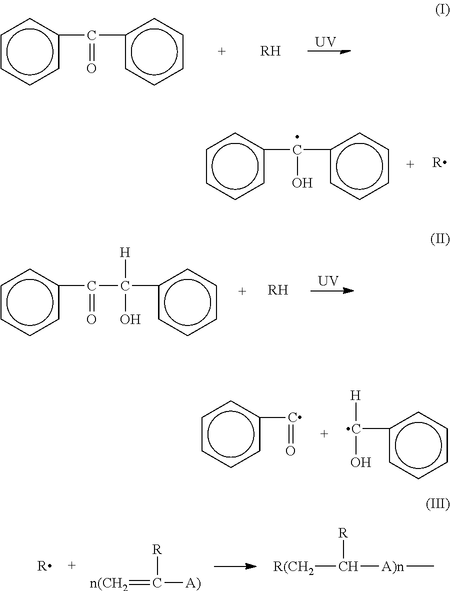

In a case in which a hydrogen atom abstraction benzophenone polymerization initiator is used, as is the case of the formula (I), the reaction speed may decrease. Therefore, in this case, an amine sensitizer is preferably used in combination to enhance the reactivity.

The amine sensitizer serves as a polymerization accelerator, and provides an effect of supplying hydrogen atom to the polymerization initiator by the hydrogen atom abstraction action thereof and another effect of preventing the oxygen in the air to cause reaction inhibition. In the formulae (I) to (III), R represents an alkyl group, A represents an acrylic monomer main backbone, and n represents an integer.

### Other Components

The active energy ray curable composition may further include other components, such as a surfactant, a polymerization inhibitor, a leveling agent, a defoamer, a fluorescence brightening agent, a permeation accelerator, a wetting agent (humectant), a fixing agent, a viscosity stabilizer, an antifungal agent, an antiseptic agent, an antioxidant, an ultraviolet absorber, a chelate agent, a pH adjuster, and a thickening agent.

### Polymerization Inhibitor

Specific examples of the polymerization inhibitor include, but are not limited to, 4-methoxy-1-naphthol, methyl hydroquinone, hydroquinone, t-butyl hydroquinone, di-t-butyl hydroquinone, methoquinone, 2,2′-dihydroxy-3,3′-di(α-methylcyclohexyl)-5,5′-dimethyldiphenylmethane, p-benzoquinone, di-t-butyl diphenyl amine, 9,10-di-n-butoxyanthracene, 4,4′-[1,10-dioxo-1,10-decanediylbis(oxy)]bis[2,2,6,6-tetramethyl]-1-piperidinyloxy, p-methoxyphenol, and 2,6-di-tert-butyl-p-cresol.

The content rate of the polymerization inhibitor is preferably in the range of from 0.005% to 3% by mass based on the total weight of the polymerization initiator. When the content rate is 0.005% by mass or more, storage stability is improved and viscosity rise is suppressed in high-temperature environments. When the content rate is 3% by mass or less, curability is improved.

### Surfactant

Specific examples of the surfactant include, but are not limited to, higher-fatty-acid-based surfactants, silicone-based surfactants, and fluorine-based surfactants.

The content rate of the surfactant in the active energy ray curable composition is preferably in the range of from 0.1% to 3% by mass, more preferably from 0.2% to 1% by mass. When the content rate is 0.1% by mass or more, wettability is improved. When the content rate is 3% by mass or less, curability is improved. When the content rate is within the above-described range, wettability and leveling property are improved.

### Organic Solvent

The active energy ray curable composition according to an embodiment of the present invention may include an organic solvent. However, it is more preferable that the active energy ray curable composition includes no organic solvent. When the active energy ray curable composition includes no organic solvent, in other words, when the composition is VOC (volatile organic compounds) free, the cured product thereof includes no residual volatile organic solvent. This improves safety at printing sites and prevents environment pollution. Organic solvents generally refer to volatile organic compounds (VOC), such as ether, ketone, xylene, ethyl acetate, cyclohexanone, and toluene, which are discriminated from reactive monomers. When the composition is stated to include no organic solvent, it means that the composition “substantially” include no organic solvent. In this case, the content rate of the organic solvent in the composition is preferably less than 0.1% by mass.

### Preparation of Active Energy Ray Curable Composition

The active energy ray curable composition may be prepared by: dispersing the polymerizable monomer, the pigment, the dispersant, etc., in a disperser (e.g., ball mill, disc mill, pin mill, DYNO-MILL) to prepare a pigment dispersion liquid; and further mixing the polymerizable monomer, a polymerization initiator, a polymerization inhibitor, a surfactant, etc., in the pigment dispersion liquid. The preparation method is not limited thereto.

### Viscosity

The viscosity of the active energy ray curable composition is adjusted in accordance with the purpose of use or application. When the active energy ray curable composition is applied to a discharge device that discharges the composition from nozzles, the viscosity of the composition is preferably adjusted to from 3 to 40 mPa·s, more preferably from 5 to 15 mPa·s, and most preferably from 6 to 12 mPa·s, at a temperature of from 20° C. to 65° C. Preferably, the active energy ray curable composition exhibits a viscosity within the above-described range without including any organic solvent. The viscosity is measured with a cone-plate rotary viscometer (VISCOMETER TVE-22L available from Toki Sangyo Co., Ltd.) using a cone rotor (1°34′×R24) while setting the revolution to 50 rpm and the temperature of the constant-temperature circulating water to from 20° C. to 65° C. The temperature of the circulating water is adjusted by an instrument VISCOMATE VM-150III.

Specific examples of the active energy ray source include, but are not limited to, a mercury lamp, a metal halide lamp, and a UV-LED lamp.

The mercury lamp may be a quartz glass luminous tube including high-purity mercury (Hg) and a small amount of a rare gas, which radiates ultraviolet ray having wavelengths of 365 nm (main wavelength), 254 nm, 303 nm, and 313 nm. The mercury lamp is characterized by high output of short-wavelength ultraviolet ray.

The metal halide lamp may be a luminous tube including mercury and a metal halide, which radiates an active energy ray spectrum in a wavelength range of from 200 to 450 nm. The metal halide lamp is characterized by higher output of long-wavelength ultraviolet ray in a wavelength range of from 300 to 450 nm than the mercury lamp.

The UV-LED lamp is preferably used for curing the active energy ray curable composition, for the following advantages: a long lifespan; a low electric power consumption; a reduced environmental load; no ozone generation; and a compact size.

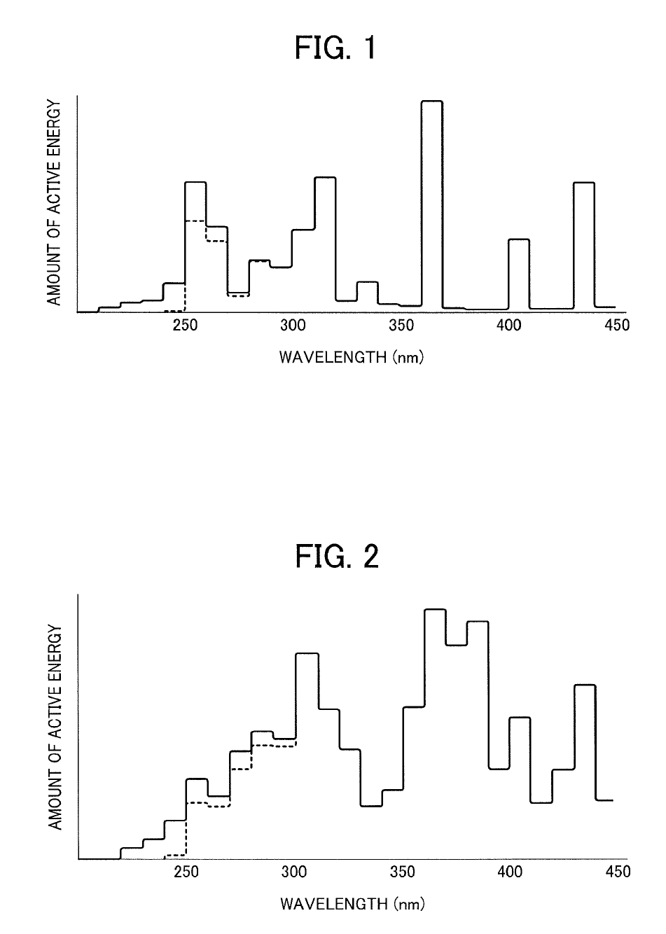

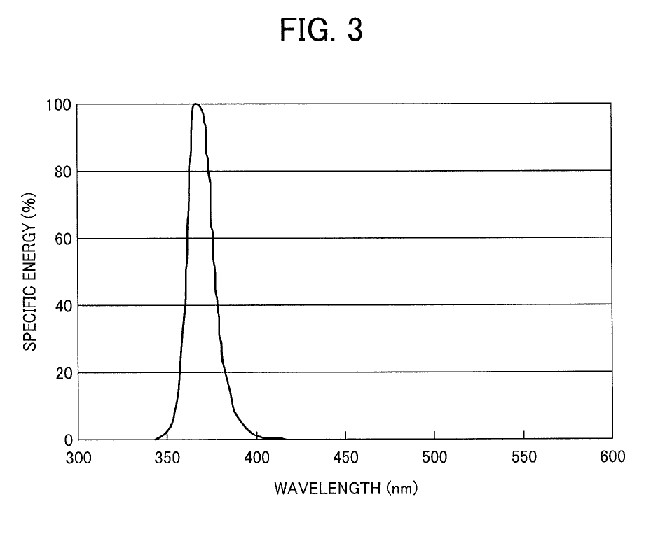

FIG. 1 is an example of an ultraviolet spectrum radiated by the mercury lamp. FIG. 2 is an example of an ultraviolet spectrum radiated by the metal halide lamp. FIG. 3 is an example of an ultraviolet spectrum radiated by the UV-LED lamp.

### Use Application

The active energy ray curable composition can be applied to, for example, modeling resins, paints, adhesives, insulating materials, release agents, coating materials, sealing materials, resists, and optical materials.

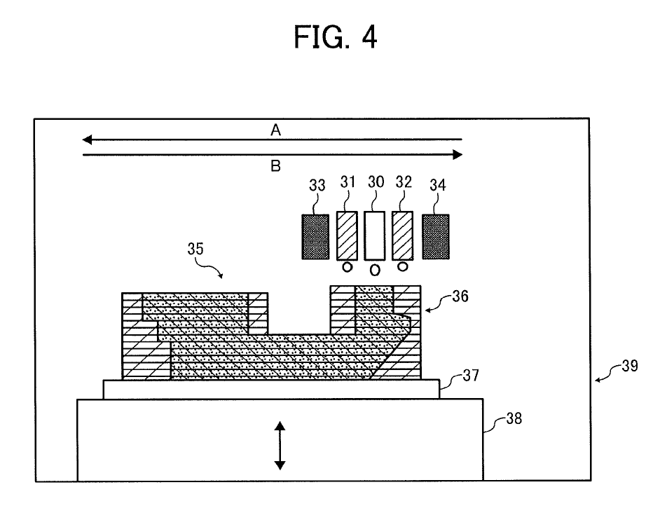

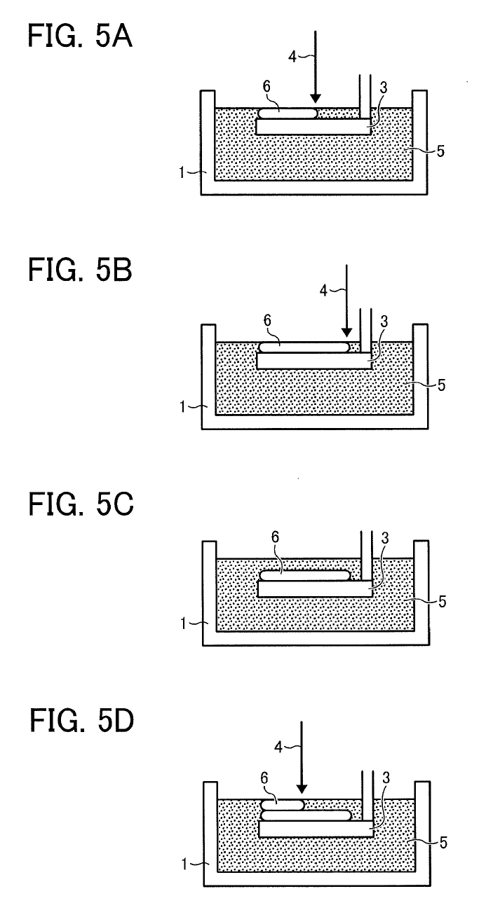

For example, the active energy ray curable composition can be applied to inks for forming two-dimensional texts and images and design coatings on various substrates. As another example, the active energy ray curable composition can be applied to stereoscopic modeling materials for forming three-dimensional images (i.e., stereoscopic modeled objects). The stereoscopic modeling material can be used as a binder for binding powder particles used for additive manufacturing in which powder layers are repeatedly cured and laminated to form a stereoscopic object. The stereoscopic modeling material can also be used as a modeling material and a support material for use in optical modeling as illustrated in FIG. 4 and FIGS. 5A to 5D. FIG. 4 is an illustration of a stereoscopic modeling method in which the active energy ray curable composition according to an embodiment of the present invention is discharged to a certain region and exposed to an active energy ray to cure, and the cured layers are sequentially laminated to form a stereoscopic object. FIGS. 5A to 5D are illustrations of another stereoscopic modeling method in which an active energy ray curable composition 5 according to an embodiment of the present invention is retained in a pool 1 and exposed to an active energy ray 4 to be formed into a cured layer 6 on a movable stage 3, and the cured layers 6 are sequentially laminated to form a stereoscopic object.

Stereoscopic modeling apparatuses for forming stereoscopic modeled objects with the active energy ray curable composition are not limited in structure and may include a storage for storing the active energy ray curable composition, a supplier, a discharger, and an active energy ray emitter.

The cured product according to an embodiment of the present invention is obtainable by causing the active energy ray curable composition to cure. The processed product according to an embodiment of the present invention is obtainable by processing a structural body including a substrate and the cured product formed on the substrate. The processed product is produced by subjecting the cured product or structural body in the form of a sheet or film to a modeling processing such as stretching processing (optionally with heat) and punching processing. The processed product is preferably used for meters and operation panels of automobiles, office automation equipments, electric or electronic devices, and cameras, which typically need to be surface-decorated.

Specific examples of the substrate include, but are not limited to, paper, thread, fiber, fabric, leather, metal, plastic, glass, wood, ceramic, and composite materials thereof. Among these materials, plastic substrates are preferable from the aspect of processability.

The cured product preferably has a stretchability of 50% or more, more preferably 100% or more, at 180° C. Here, the stretchability is defined by the following formula: (L2−L1)/L1, wherein L1 represents a first length of the cured product before a tensile test and L2 represents a second length of the cured product after the tensile test.

### Active Energy Ray Curable Ink

The active energy ray curable ink according to an embodiment of the present invention includes the active energy ray curable composition according to an embodiment of the present invention. The active energy ray curable ink is preferably used for as an inkjet ink.

The active energy ray curable ink preferably has a static surface tension in the range of from 20 to 40 N/m, more preferably from 28 to 35 N/m, at 25° C.

The static surface tension is measured with a static surface tensiometer (CBVP-Z available from Kyowa Interface Science Co., Ltd.) at 25° C. The above-described preferred range of static surface tension is determined under an assumption that the ink is used for commercially-available inkjet head (e.g., GEN4 from Ricoh Printing Systems, Ltd.)

### Composition Storage Container

The composition storage container according to an embodiment of the present invention includes a container and the above-described active energy ray curable composition contained in the container. When the active energy ray curable composition is used for an ink, the active energy ray curable composition container serves as an ink cartridge or an ink bottle, which prevents user from directly contacting the ink when the user is replacing the ink, thus preventing user's fingers and clothes from being contaminated with the ink. In addition, the ink cartridge or ink bottle prevents foreign substances from being mixed into the ink. The container is not limited in shape, size, and material. Preferably, the container is made of a light-blocking material or covered with a light-blocking sheet.

### Image Forming Method and Image Forming Apparatus

The two-dimensional or three-dimensional image forming method according to an embodiment of the present invention includes at least the process of emitting an active energy ray to the active energy ray curable composition to cause the active energy ray curable composition to cure. The two-dimensional or three-dimensional image forming apparatus according to an embodiment of the present invention includes at least an emitter to emit an active energy ray to the active energy ray curable composition and a storage to store the active energy ray curable composition. The storage may include the above-described composition storage container. The two-dimensional or three-dimensional image forming method may further include the process of discharging the active energy ray curable composition. The two-dimensional or three-dimensional image forming apparatus may further include a discharger to discharge the active energy ray curable composition. The discharging method may be of a continuous injection type or an on-demand type, but is not limited thereto. Specific examples of the on-demand-type discharging method include thermal methods and electrostatic methods.

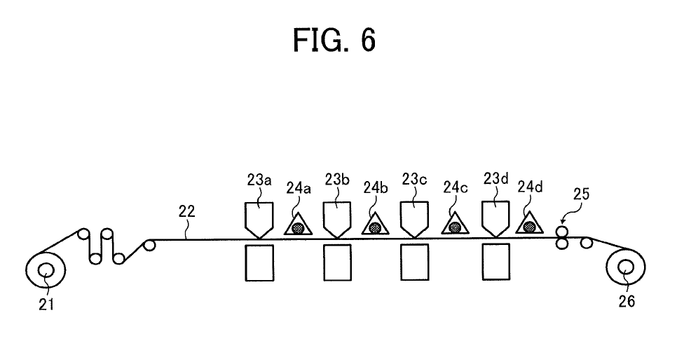

FIG. 6 is a schematic view of an image forming apparatus according to an embodiment of the present invention, which includes an inkjet discharger. The image forming apparatus illustrated in FIG. 6 includes printing units 23a, 23b, 23c, and 23d and a supply roller 21. Each of the printing units 23a, 23b, 23c, and 23d includes an ink cartridge containing an active energy ray curable ink having yellow, magenta, cyan, and black colors, respectively, and a discharge head. The inks are discharged to a recording medium 22 supplied by the supply roller 21. Light sources 24a, 24b, 24c, and 24d emit active energy rays to the respective inks on the recording medium 22 to cause the inks to cure and form color images. The recording medium 22 is then conveyed to a winding roller 26 via a processing unit 25. Each of the printing units 23a, 23b, 23c, and 23d may be equipped with a heater for liquefying the ink at the inkjet discharger. Furthermore, the printing units 23a, 23b, 23c, and 23d may be equipped with a cooler for cooling the recording medium to room temperature with or without contacting the recording medium. The image forming apparatus illustrated in FIG. 6 may be an inkjet recording apparatus employing a serial method or a line method. In the serial method, ink is discharged from a moving discharge head onto a recording medium that is intermittently moved in accordance with the width of the discharge head. In the line method, ink is discharged from a fixed discharge head onto a recording medium that is continuously moved.

Specific preferred materials for the recording medium 22 include, but are not limited to, paper, film, metal, and composite materials thereof, which may be in the form of a sheet. The image forming apparatus illustrated in FIG. 6 may be capable of either one-side printing or duplex printing.

It is possible that the light sources 24a, 24b, and 24c emit weakened active energy rays or no active energy ray and the light source 24d emits an active energy ray after multiple color images have been printed. In this case, energy consumption and cost are reduced.

Recorded matters recorded by the ink according to an embodiment of the present invention include those printed on smooth surfaces such as normal paper and resin films, those printed on irregular surfaces, and those printed on surfaces of various materials such as metal and ceramics. By laminating two-dimensional images, a partially-stereoscopic image (including two-dimensional parts and three-dimensional parts) or a stereoscopic product can be obtained.

FIG. 4 is a schematic view of a three-dimensional image forming apparatus according to an embodiment of the present invention. Referring to FIG. 4, an image forming apparatus 39 includes a discharge head unit 30 for forming modeled object layers, discharge head units 31 and 32 for forming support layers, and ultraviolet emitters 33 and 34 adjacent to the discharge head units 30, 31, and 32. Each of the discharge head units 30, 31, and 32 includes an inkjet head and is movable in the directions indicated by arrows A and B in FIG. 4. The discharge head unit 30 discharges a first active energy ray curable composition, and the discharge head units 31 and 32 each discharge a second active energy ray curable composition different from the first active energy ray curable composition. The ultraviolet emitters 33 and 34 cause the active energy ray curable compositions to cure. The cured products are laminated in the image forming apparatus 39. More specifically, first, the second active energy ray curable composition is discharged from the discharge head units 31 and 32 onto a modeled object supporting substrate 37 and exposed to an active energy ray to cure, thus forming a first support layer having a reservoir. Next, the first active energy ray curable composition is discharged from the discharge head unit 30 onto the reservoir and exposed to an active energy ray to cure, thus forming a first modeled object layer. These processes are repeated multiple times, in accordance with the set number of lamination, while lowering a stage 38 that is movable in the vertical direction, to laminate the support layers and the modeled object layers. Thus, a stereoscopic modeled object 35 is obtained. A support layer lamination 36 is removed thereafter, if necessary. In the embodiment illustrated in FIG. 4, the number of discharge head unit 30 for forming modeled object layers is one. Alternatively, the number thereof may be two or more.

Specific examples of the two-dimensional image include texts, symbols, graphics, and combinations thereof, and solid images.

Specific examples of the three-dimensional image include stereoscopic modeled objects.

Preferably, the stereoscopic modeled object has an average thickness of 10 μm or more.

The two-dimensional or three-dimensional image is formed from the active energy ray curable composition or active energy ray curable ink according to an embodiment of the present invention. Therefore, the two-dimensional or three-dimensional image, when formed on a non-permeable substrate, maintains good adhesion to the substrate even after being dipped in water, thus providing excellent water resistance.

Preferably, the two-dimensional or three-dimensional image is formed by emitting light-emitting diode light to the active energy ray curable composition or ink to cause the active energy ray curable composition or ink to cure.

### EXAMPLES

Having generally described this invention, further understanding can be obtained by reference to certain specific examples which are provided herein for the purpose of illustration only and are not intended to be limiting.

The absorption amount and non-absorption amount of the dispersant, the volume average particle diameter of the active energy ray curable composition, and the number average primary particle diameter of the pigment were measured in the following manner.

### Absorption Amount of Dispersant

First, 1.5 g of a sample (e.g., ink) was weighed in a 1-ml sample holder used for centrifugal separation. The sample was subject to a centrifugal separation at a revolution of 10,000 rpm for 1 hour, and the resulting supernatant was removed thereafter. The same amount of acetone as the removed supernatant was added to the holder. The holder contents were stirred with a spatula and subject to the centrifugal separation four times, followed by a complete drying by a vacuum drier. About 100 mg of the dried sample was precisely weighed in an aluminum cup and heated at 400° C. for 2 hours. After the heating, the residual amount of the sample was measured. The adsorption amount of the dispersant was calculated from the following formula:

Amount of Dispersant Adsorbed to 1 g of Pigment=1,000 (mg)/Residual Amount after Heating (mg)×Decreased Amount after Heating (mg)

### Non-Adsorption Amount of Dispersant

The amount of the dispersant not adsorbed to the pigment was calculated by the following formula:

(Blending Amount of Dispersant/Blending Amount of Pigment)×1,000 (mg)−Amount of Dispersant Adsorbed to 1 g of Pigment (mg)

### Volume Average Particle Diameter of Active Energy Ray Curable Composition

First, the active energy ray curable composition was diluted to about 100 times with phenoxyethyl acrylate. The dilution was subject to a measurement with a particle size analyzer (UPA150 available from Nikkiso Co., Ltd.) to determine volume average particle diameter and volume particle diameter distribution. The contents of those having a volume particle diameter of 170 nm or less and those having a volume particle diameter of 380 nm or more were calculated from the volume particle diameter distribution.

### Number Average Primary Particle Diameter of Pigment

The number average primary particle diameter of the pigment was measured by observing the active energy ray curable composition with a scanning electron microscope (SU3500 available from Hitachi High-Technologies Corporation) at a magnification of 10,000 times, measuring the unidirectional particle diameter of each of 200 to 500 primary particles existing between a pair of parallel lines, and averaging the measured unidirectional particle diameters.

### Preparation of Pigment Dispersions

### Preparation of Pigment Dispersion A

First, 110 parts by mass of a titanium oxide A (TCR-52 available from Sakai Chemical Industry Co., Ltd., surface-treated with Al₂O₃), 4 parts by mass of an amine-group-containing acrylic block copolymer (BYKJET-9151 available from BYK Japan KK, having an acid value of 8 mgKOH/g and an amine value of 18 mgKOH/g, serving as the dispersant), and 56 parts by mass of phenoxy acrylate (available from Osaka Organic Chemical Industry Ltd.) were subject to a dispersion treatment in a 500-mL ball mill filled with zirconia beads having a diameter of 2 mm (at a filling rate of 45% by volume) at a revolution of 70 rpm and a dispersing temperature of 25° C. for 96 hours. After further adding 50 parts by mass of phenoxyethyl acrylate (available from Osaka Organic Chemical Industry Ltd.), the mixture was subject to a dispersion treatment for 30 minutes. The mixture was then put in a 1-L sand mill filled with zirconia beads having a diameter of 0.1 mm (at a filling rate of 80% by volume) and subject to a dispersion treatment at a peripheral speed of 8 m/sec and a dispersing temperature of 25° C. for 3 hours. Thus, a pigment dispersion A was prepared.

### Preparation of Pigment Dispersion B

First, 110 parts by mass of a titanium oxide A (TCR-52 available from Sakai Chemical Industry Co., Ltd., surface-treated with Al₂O₃), 3 parts by mass of an amine-group-containing acrylic block copolymer (BYKJET-9151 available from BYK Japan KK, having an acid value of 8 mgKOH/g and an amine value of 18 mgKOH/g, serving as the dispersant), and 57 parts by mass of phenoxy acrylate (available from Osaka Organic Chemical Industry Ltd.) were subject to a dispersion treatment using a homogenizer at a revolution of 5,000 rpm and a dispersing temperature of 35° C. for 20 minutes. The mixture was then subject to a dispersion treatment in a 1-L sand mill filled with zirconia beads having a diameter of 0.3 mm (at a filling rate of 90% by volume) at a peripheral speed of 10 m/sec and a dispersing temperature of 30° C. for 1 hour. After further adding 50 parts by mass of phenoxyethyl acrylate (available from Osaka Organic Chemical Industry Ltd.), the mixture was subject to a dispersion treatment for 20 minutes. Thus, a pigment dispersion B was prepared.

### Preparation of Pigment Dispersion C

First, 110 parts by mass of a titanium oxide B (S3618 available from Sakai Chemical Industry Co., Ltd., surface-treated with Al₂O₃), 2 parts by mass of a comb-shaped aliphatic amine resin dispersant having a polyethyleneimine main backbone (SOLSPERSE 39000 available from The Lubrizol Corporation, having an acid value of 33 mgKOH/g and an amine value of 0 mgKOH/g, serving as the dispersant), and 58 parts by mass of acryloyl morpholine (available from KOHJIN Film & Chemicals Co., Ltd.) were subject to a dispersion treatment in a 500-mL ball mill filled with zirconia beads having a diameter of 2 mm (at a filling rate of 43% by volume) at a revolution of 70 rpm and a dispersing temperature of 25° C. for 180 hours, and 50 parts by mass of acryloyl morpholine (available from KOHJIN Film & Chemicals Co., Ltd.) was further added thereafter. Thus, a pigment dispersion C was prepared.

### Preparation of Pigment Dispersion D

First, 110 parts by mass of a titanium oxide C (JR403 available from Tayca Corporation, surface-treated with Al₂O₃ and SiO₂), 6 parts by mass of an amine-group-containing acrylic block copolymer (BYKJET-9151 available from BYK Japan KK, having an acid value of 8 mgKOH/g and an amine value of 18 mgKOH/g, serving as the dispersant), and 54 parts by mass of 2-vinyloxyethoxyethyl acrylate (available from NIPPON SHOKUBAI CO., LTD.) were subject to a dispersion treatment in a 500-mL ball mill filled with zirconia beads having a diameter of 2 mm (at a filling rate of 45% by volume) at a revolution of 70 rpm and a dispersing temperature of 25° C. for 200 hours, and 50 parts by mass of 2-vinyloxyethoxyethyl acrylate (available from NIPPON SHOKUBAI CO., LTD.) was further added thereafter. Thus, a pigment dispersion D was prepared.

### Preparation of Pigment Dispersion E

First, 110 parts by mass of a titanium oxide B (S3618 available from Sakai Chemical Industry Co., Ltd., surface-treated with Al₂O₃), 10 parts by mass of a comb-shaped aliphatic amine resin dispersant having a polyethyleneimine main backbone (SOLSPERSE 39000 available from The Lubrizol Corporation, having an acid value of 33 mgKOH/g and an amine value of 0 mgKOH/g, serving as the dispersant), and 50 parts by mass of 4-hydroxybutyl acrylate (available from Osaka Organic Chemical Industry Ltd.) were subject to a dispersion treatment using a homogenizer at a revolution of 8,000 rpm and a dispersing temperature of 35° C. for 15 minutes. The mixture was then subject to a dispersion treatment in a sand mill filled with zirconia beads having a diameter of 0.3 mm (at a filling rate of 80% by volume) at a peripheral speed of 8 m/sec and a dispersing temperature of 30° C. for 1 hour, and 55 parts by mass of 4-hydroxybutyl acrylate (available from Osaka Organic Chemical Industry Ltd.) was further added thereafter. Thus, a pigment dispersion E was prepared.

### Preparation of Pigment Dispersion F

The procedure for preparing the pigment dispersion A was repeated except for replacing the titanium oxide A (TCR-52 available from Sakai Chemical Industry Co., Ltd., surface-treated with Al₂O₃) with a titanium oxide D (JR available from Tayca Corporation, no surface treatment). Thus, a pigment dispersion F was prepared.

### Preparation of Pigment Dispersion G

The procedure for preparing the pigment dispersion B was repeated except for replacing the titanium oxide A (TCR-52 available from Sakai Chemical Industry Co., Ltd., surface-treated with Al₂O₃) with a titanium oxide E (JR301 available from Tayca Corporation, surface-treated with Al₂O₃) Thus, a pigment dispersion G was prepared.

### Preparation of Pigment Dispersion H (Used in Comparative Example 4)

First, 110 parts by mass of a titanium oxide F (JR405 available from Tayca Corporation, surface-treated with Al₂O₃), 15 parts by mass of an amine-group-containing acrylic block copolymer (BYKJET-9151 available from BYK Japan KK, having an acid value of 8 mgKOH/g and an amine value of 18 mgKOH/g, serving as the dispersant), and 95 parts by mass of acryloyl morpholine (available from KOHJIN Film & Chemicals Co, Ltd.) were subject to a dispersion treatment in a 500-mL ball mill filled with zirconia beads having a diameter of 1 mm (at a filling rate of 48% by volume) at a revolution of 70 rpm and a dispersing temperature of 35° C. for 240 hours. Thus, a pigment dispersion H was prepared.

### Preparation of Pigment Dispersion I

The procedure for preparing the pigment dispersion D was repeated except for replacing the amine-group-containing acrylic block copolymer (BYKJET-9151 available from BYK Japan KK, having an acid value of 8 mgKOH/g and an amine value of 18 mgKOH/g, serving as the dispersant) with a dicarboxylate-containing diacrylic block copolymer (DISPERBYK-168 available from BYK Japan KK, having an acid value of 0 mgKOH/g and an amine value of 11 mgKOH/g, serving as the dispersant). Thus, a pigment dispersion I was prepared.

### Preparation of Pigment Dispersion J (Used in Comparative Example 1)

First, 110 parts by mass of a titanium oxide B (S3618 available from Sakai Chemical Industry Co., Ltd., surface-treated with Al₂O₃), 5 parts by mass of a dicarboxylate-containing diacrylic block copolymer (DISPERBYK-168 available from BYK Japan KK, having an acid value of 0 mgKOH/g and an amine value of 11 mgKOH/g, serving as the dispersant), and 105 parts by mass of 4-hydroxybutyl acrylate (available from Osaka Organic Chemical Industry Ltd.) were subject to a dispersion treatment using a homogenizer at a revolution of 8,000 rpm and a dispersing temperature of 35° C. for 15 minutes. The mixture was then subject to a dispersion treatment in a sand mill filled with zirconia beads having a diameter of 0.5 mm (at a filling rate of 75% by volume) at a peripheral speed of 8 m/sec and a dispersing temperature of 25° C. for 1 hour. Thus, a pigment dispersion J was prepared.

### Preparation of Pigment Dispersion K (Used in Comparative Example 2)

First, 110 parts by mass of a titanium oxide H (R54M available from Sakai Chemical Industry Co., Ltd., surface-treated with Al₂O₃ and SiO₂), 20 parts by mass of a comb-shaped aliphatic amine resin dispersant having a polyester imine main backbone (SOLSPERSE 39000 available from The Lubrizol Corporation, having an acid value of 33 mgKOH/g and an amine value of 0 mgKOH/g, serving as the dispersant), and 50 parts by mass of acryloyl morpholine (available from KOHJIN Film & Chemicals Co., Ltd.) were subject to a dispersion treatment in a 500-mL ball mill filled with zirconia beads having a diameter of 1 mm (at a filling rate of 46% by volume) at a revolution of 70 rpm and a dispersing temperature of 35° C. for 280 hours. After further adding 40 parts by mass of acryloyl morpholine (available from KOHJIN Film & Chemicals Co., Ltd.), the mixture was subject to a dispersion treatment for 10 hours. Thus, a pigment dispersion K was prepared.

### Preparation of Pigment Dispersion L

The procedure for preparing the pigment dispersion B was repeated except for replacing the dispersion treatment performed using a homogenizer at a revolution of 5,000 rpm and a dispersing temperature of 35° C. for 20 minutes with another dispersion treatment which uses a DYNO-MILL filled with zirconia beads having a diameter of 1.0 mm (at a filling rate of 80% by volume). Thus, a pigment dispersion L was prepared.

### Preparation of Pigment Dispersion M

The procedure for preparing the pigment dispersion B was repeated except for replacing the titanium oxide A (TCR-52 available from Sakai Chemical Industry Co., Ltd., surface-treated with Al₂O₃) with a titanium oxide I (R21 available from Sakai Chemical Industry Co., Ltd., surface-treated with Al₂O₃ and SiO₂). Thus, a pigment dispersion M was prepared.

### Preparation of Pigment Dispersion N (Used in Comparative Example 3)

### Preparation of Titanium Oxide J

The titanium oxide A (TCR-52 available from Sakai Chemical Industry Co., Ltd., surface-treated with Al₂O₃) was surface-treated with an organosiloxane. Thus, a titanium oxide J, having improved hydrophobicity, was prepared.

### Preparation of Pigment Dispersion N

First, 110 parts by mass of the titanium oxide J, 2 parts by mass of a dicarboxylate-containing diacrylic block copolymer (DISPERBYK-168 available from BYK Japan KK, having an acid value of 0 mgKOH/g and an amine value of 11 mgKOH/g, serving as the dispersant), and 108 parts by mass of phenoxyethyl acrylate (available from Osaka Organic Chemical Industry Ltd.) were subject to a dispersion treatment in a 500-mL ball mill filled with zirconia beads having a diameter of 3 mm (at a filling rate of 40% by volume) at a revolution of 70 rpm and a dispersing temperature of 25° C. for 72 hours. Thus, a pigment dispersion N was prepared.

### Preparation of Pigment Dispersion O

The procedure for preparing the pigment dispersion B was repeated except for replacing the amine-group-containing acrylic block copolymer (BYKJET-9151 available from BYK Japan KK, having an acid value of 8 mgKOH/g and an amine value of 18 mgKOH/g, serving as the dispersant) with a butyl-acetate-containing acrylic block copolymer (DISPERBYK-167 available from BYK Japan KK, having an acid value of 0 mgKOH/g and an amine value of 13 mgKOH/g). Thus, a pigment dispersion O was prepared.

The compositions of the pigment dispersions A to O are described in Tables 1 to 3.

TABLE 1

| | | Pigment Dispersions | | | | | |
|---|---|---|---|---|---|---|---|
| | | A | B | C | D | E | F |
| Pigments | Titanium Oxide A | 110 | 110 | | | | |
| | Titanium Oxide B | | | 110 | | 110 | |
| | Titanium Oxide C | | | | 110 | | |
| | Titanium Oxide D | | | | | | 110 |
| | Titanium Oxide E | | | | | | |
| | Titanium Oxide F | | | | | | |
| | Titanium Oxide G | | | | | | |
| | Titanium Oxide H | | | | | | |
| | Titanium Oxide I | | | | | | |
| | Titanium Oxide J | | | | | | |
| Dispersants | Amine-group-containing | 4 | 3 | | 6 | | 4 |
| | Acrylic Block Copolymer¹⁾ | | | | | | |
| | Comb-shaped Aliphatic | | | 2 | | 10 | |
| | Amine Resin Dispersant | | | | | | |
| | having Polyethyleneimine | | | | | | |
| | Main Backbone²⁾ | | | | | | |
| | Dicarboxylate-containing | | | | | | |
| | Diacrylic Block Copolymer³⁾ | | | | | | |
| | Butyl-acetate-containing | | | | | | |
| | Acrylic Block Copolymer⁴⁾ | | | | | | |
| Polymerizable | Phenoxyethyl Acrylate | 106 | 107 | | | | 106 |
| Compounds | Acryloyl Morpholine | | | 108 | | | |
| | 2-Vinyloxyethoxyethyl | | | | 104 | | |
| | Acrylate | | | | | | |
| | 4-Hydroxybutyl Acrylate | | | | | 105 | |

| | | | | | | |
|---|---|---|---|---|---|---|
| Surface Treatment of Pigment | Al₂O₃ | Al₂O₃ | Al₂O₃ | Al₂O₃ | Al₂O₃ | |
| | | | | SiO₂ | | |
| Pre-dispersing Method | Ball | Homogenizer | | | Homogenizer | Ball |
| | Mill | | | | | Mill |
| Main-dispersing Method | Sand | Sand | Ball | Ball | Sand | Sand |
| | Mill | Mill | Mill | Mill | Mill | Mill |

¹⁾Acid Value: 8 mgKOH/g, Amine Value: 18 mgKOH/g
²⁾Acid Value: 33 mgKOH/g, Amine Value: 0 mgKOH/g
³⁾Acid Value: 0 mgKOH/g, Amine Value: 11 mgKOH/g
⁴⁾Acid Value: 0 mgKOH/g, Amine Value: 13 mgKOH/g

TABLE 2

| | | Pigment Dispersions | | | | | |
|---|---|---|---|---|---|---|---|
| | | G | H | I | J | K | L |
| Pigments | Titanium Oxide A | | | | | | 110 |
| | Titanium Oxide B | | | | 110 | | |
| | Titanium Oxide C | | | 110 | | | |
| | Titanium Oxide D | | | | | | |
| | Titanium Oxide E | 110 | | | | | |
| | Titanium Oxide F | | 110 | | | | |
| | Titanium Oxide G | | | | | | |
| | Titanium Oxide H | | | | | 110 | |
| | Titanium Oxide I | | | | | | |
| | Titanium Oxide J | | | | | | |
| Dispersants | Amine-group-containing | 3 | 15 | | | | 4 |
| | Acrylic Block Copolymer | | | | | | |
| | Comb-shaped Aliphatic | | | | | 20 | |
| | Amine Resin Dispersant | | | | | | |
| | having Polyethyleneimine | | | | | | |
| | Main Backbone | | | | | | |
| | Dicarboxylate-containing | | | 2 | 5 | | |
| | Diacrylic Block Copolymer | | | | | | |
| | Butyl-acetate-containing | | | | | | |
| | Acrylic Block Copolymer | | | | | | |
| Polymerizable | Phenoxyethyl Acrylate | 107 | | | | | 106 |
| Compounds | Acryloyl Morpholine | | 95 | 108 | | 90 | |
| | 2-Vinyloxyethoxyethyl | | | | 105 | | |
| | Acrylate | | | | | | |
| | 4-Hydroxybutyl Acrylate | | | | | | |

| | | | | | | |
|---|---|---|---|---|---|---|
| Surface Treatment of Pigment | Al₂O₃ | Al₂O₃ | Al₂O₃ | Al₂O₃ | Al₂O₃ | Al₂O₃ |
| | | | | | SiO₂ | |
| Pre-dispersing Method | Homogenizer | | | Homogenizer | | |
| Main-dispersing Method | Sand | Ball | Ball | Sand | Ball | Sand |
| | Mill | Mill | Mill | Mill | Mill | Mill |

TABLE 3

| | | Pigment Dispersions | | |
|---|---|---|---|---|
| | | M | N | O |
| Pigments | Titanium Oxide A | | | 110 |
| | Titanium Oxide B | | | |
| | Titanium Oxide C | | | |
| | Titanium Oxide D | | | |
| | Titanium Oxide E | | | |
| | Titanium Oxide F | | | |
| | Titanium Oxide G | | | |
| | Titanium Oxide H | | | |
| | Titanium Oxide I | 110 | | |
| | Titanium Oxide J | | 110 | |
| Dispersants | Amine-group-containing | 3 | | |
| | Acrylic Block Copolymer | | | |
| | Comb-shaped Aliphatic | | | |
| | Amine Resin Dispersant | | | |
| | having Polyethyleneimine | | | |
| | Main Backbone | | | |
| | Dicarboxylate-containing | | 2 | |
| | Diacrylic Block Copolymer | | | |
| | Butyl-acetate-containing | | | 3 |
| | Acrylic Block Copolymer | | | |
| Poly- | Phenoxyethyl Acrylate | 107 | 108 | 107 |
| merizable | Acryloyl Morpholine | | | |
| Compounds | 2-Vinyloxyethoxyethyl | | | |
| | Acrylate | | | |
| | 4-Hydroxybutyl Acrylate | | | |

| | | | |
|---|---|---|---|
| Surface Treatment of Pigment | Al₂O₃ | Al₂O₃ | Al₂O₃ |
| | SiO₂ | Hydro- | |
| | | phobized | |
| Pre-dispersing Method | Homog- | | Homog- |
| | enizer | | enizer |
| Main-dispersing Method | Sand | Ball | Sand |
| | Mill | Mill | Mill |

### Example 1

An active energy ray curable composition 1 was prepared by mixing 30 parts by mass of the pigment dispersion A, 45 parts by mass of benzyl acrylate (available from Osaka Organic Chemical Industry Ltd.), 5 parts by mass of tripropylene glycol diacrylate (available from Shin Nakamura Chemical Co., Ltd.), 5 parts by mass of pentaerythritol triacrylate (available from Shin Nakamura Chemical Co., Ltd.), 6 parts by mass of bis(2,4,6-trimethylbenzoyl)-phenylphosphine oxide (IRGACURE 819 available from BASF), 5 parts by mass of 2,4,6-trimethylbenzoyl-diphenyl-phosphine oxide (LUCIRIN TPO available from BASF), 3.5 parts by mass of 2,4-diethylthioxanthone 1 (Speedcure DETX available from Lambson Limited), 0.2 parts by mass of p-methoxyphenol (available from Nippon Kayaku Co., Ltd.), and 0.3 parts by mass of a polyether-modified polydimethylsiloxane (BYK3510 available from BYK Japan KK).

### Example 2

An active energy ray curable composition 2 was prepared by mixing 30 parts by mass of the pigment dispersion A, 35 parts by mass of tripropylene glycol diacrylate (available from Shin Nakamura Chemical Co., Ltd.), 35 parts by mass of acryloyl morpholine (available from KOHJIN Film & Chemicals Co., Ltd.), 6 parts by mass of an urethane acrylate oligomer (EBECRYL 8402 available from DAICEL-ALLNEX LTD.), 3.5 parts by mass of 2-benzyl-2-dimethylamino-1-(4-morpholinophenyl)-butanone-1 (IRGACURE 369 available from BASF), 0.2 parts by mass of p-methoxyphenol (available from Nippon Kayaku Co., Ltd.), and 0.3 parts by mass of an acrylic-functional-group-containing modified polydimethylsiloxane 1 (BYK-3576 available from BYK Japan KK).

### Example 3

The procedure of Example 1 was repeated except for replacing the pigment dispersion A with the pigment dispersion F. Thus, an active energy ray curable composition 3 was prepared.

### Example 4

An active energy ray curable composition 4 was prepared by mixing 30 parts by mass of the pigment dispersion B, 40 parts by mass of benzyl acrylate (available from Osaka Organic Chemical Industry Ltd.), 15 parts by mass of tripropylene glycol diacrylate (available from Shin Nakamura Chemical Co., Ltd.), 7 parts by mass of pentaerythritol triacrylate (available from Shin Nakamura Chemical Co., Ltd.), 5 parts by mass of bis(2,4,6-trimethylbenzoyl)-phenylphosphine oxide (IRGACURE 819 available from BASF), 3 parts by mass of 2,4,6-trimethylbenzoyl-diphenyl-phosphine oxide (LUCIRIN TPO available from BASF), 3.5 parts by mass of 2,4-diethylthioxanthone (Speedcure DETX available from Lambson Limited), 0.2 parts by mass of p-methoxyphenol (available from Nippon Kayaku Co., Ltd.), and 0.3 parts by mass of a polyether-modified polydimethylsiloxane (BYK3510 available from BYK Japan KK).

### Example 5

An active energy ray curable composition 5 was prepared by mixing 30 parts by mass of the pigment dispersion B, 20 parts by mass of isobornyl acrylate (available from Osaka Organic Chemical Industry Ltd.), 25 parts by mass of 2-methyl-2-ethyl-1,3-dioxolan-4-ylmethyl acrylate (available from Osaka Organic Chemical Industry Ltd.), 20 parts by mass of dimethylol tricyclodecane diacrylate (available from Nippon Kayaku Co., Ltd.), 4.5 parts by mass of 2-methyl-1-(4-methylthiophenyl)-2-morpholinopropane-1-one (available from Osaka Organic Chemical Industry Ltd.), 0.2 parts by mass of p-methoxyphenol (available from Nippon Kayaku Co., Ltd.), and 0.3 parts by mass of a crosslinkable-functional-group-containing modified polyether.

### Example 6

The procedure of Example 4 was repeated except for replacing the pigment dispersion B with the pigment dispersion G. Thus, an active energy ray curable composition 6 was prepared.

### Example 7

The procedure of Example 4 was repeated except for replacing the pigment dispersion B with the pigment dispersion M. Thus, an active energy ray curable composition 7 was prepared.

### Example 8

The procedure of Example 4 was repeated except for replacing the pigment dispersion B with the pigment dispersion L. Thus, an active energy ray curable composition 8 was prepared.

### Example 9

The procedure of Example 4 was repeated except for replacing the pigment dispersion B with the pigment dispersion O. Thus, an active energy ray curable composition 9 was prepared.

### Example 10

An active energy ray curable composition 10 was prepared by mixing 30 parts by mass of the pigment dispersion C, 35 parts by mass of acryloyl morpholine (available from KOHJIN Film & Chemicals Co., Ltd.), 20 parts by mass of isobornyl acrylate (available from Osaka Organic Chemical Industry Ltd.), 15 parts by mass of dipentaerythritol pentaacrylate (available from Sartomer), 5 parts by mass of bis(2,4,6-trimethylbenzoyl)-phenylphosphine oxide (IRGACURE 819 available from BASF), 5 parts by mass of 2,4,6-trimethylbenzoyl-diphenyl-phosphine oxide (LUCIRIN TPO available from BASF), 4.5 parts by mass of 2-isopropylthioxanthone (Speedcure ITX available from Lambson Limited), 0.2 parts by mass of 2,6-di-tert-butyl-p-cresol (available from Nippon Kayaku Co., Ltd.), and 0.3 parts by mass of an acrylic-functional-group-containing modified polydimethylsiloxane 2 (BYK-3575 available from BYK Japan KK).

### Example 11

An active energy ray curable composition 11 was prepared by mixing 30 parts by mass of the pigment dispersion E, 5 parts by mass of tripropylene glycol diacrylate (available from Shin Nakamura Chemical Co., Ltd.), 5 parts by mass of pentaerythritol triacrylate (available from Shin Nakamura Chemical Co., Ltd.), 45 parts by mass of 4-hydroxybutyl acrylate (available from Osaka Organic Chemical Industry Ltd.), 6 parts by mass of bis(2,4,6-trimethylbenzoyl)-phenylphosphine oxide (IRGACURE 819 available from BASF), 5 parts by mass of 2,4,6-trimethylbenzoyl-diphenyl-phosphine oxide (LUCIRIN TPO available from BASF), 3.5 parts by mass of 2,4-diethylthioxanthone (Speedcure DETX available from Lambson Limited), 0.2 parts by mass of p-methoxyphenol (available from Nippon Kayaku Co., Ltd.), and 0.3 parts by mass of a polyether-modified polydimethylsiloxane (BYK-3510 available from BYK Japan KK).

### Example 12

An active energy ray curable composition 12 was prepared by mixing 30 parts by mass of the pigment dispersion D, 57 parts by mass of tetrahydrofurfuryl acrylate (available from Hitachi Chemical Company, Ltd.), 8 parts by mass of bis(2,4,6-trimethylbenzoyl)-phenylphosphine oxide (IRGACURE 819 available from BASF), 4.5 parts by mass of 2,4-diethylthioxanthone 2 (KAYACURE DETX-S available from Nippon Kayaku Co., Ltd.), 0.2 parts by mass of p-methoxyphenol (available from Nippon Kayaku Co., Ltd.), and 0.3 parts by mass of a polyether-modified polydimethylsiloxane (BYK3510 available from BYK Japan KK).

### Example 13

The procedure of Example 12 was repeated except for replacing the pigment dispersion D with the pigment dispersion I. Thus, an active energy ray curable composition 13 was prepared.

### Comparative Example 1

The procedure of Example 4 was repeated except for replacing the pigment dispersion B with the pigment dispersion J. Thus, an active energy ray curable composition 14 was prepared.

### Comparative Example 2

The procedure of Example 4 was repeated except for replacing the pigment dispersion B with the pigment dispersion K. Thus, an active energy ray curable composition 15 was prepared.

### Comparative Example 3

The procedure of Example 4 was repeated except for replacing the pigment dispersion B with the pigment dispersion N. Thus, an active energy ray curable composition 16 was prepared.

### Comparative Example 4

The procedure of Example 10 was repeated except for replacing the pigment dispersion C with the pigment dispersion H. Thus, an active energy ray curable composition 17 was prepared.

The compositions of the above-prepared active energy ray curable compositions are described in Tables 4 to 6. The absorption and non-absorption amounts of the dispersant and the ratio therebetween before and after a storage at 70° C. for 2 weeks are described in Table 7.

The ratio between the absorption amounts before and after the storage is also described in Table 7.

TABLE 4

| | | | Examples | | | | | |
|---|---|---|---|---|---|---|---|---|
| | | | 1 | 2 | 3 | 4 | 5 | 6 |
| Pigment Dispersions | | Types | A | A | F | B | B | G |
| | | Content | 30 | 30 | 30 | 30 | 30 | 30 |
| Polymerizable | Polymerizable | Benzyl Acrylate | 45 | — | 45 | 40 | — | 40 |
| Compounds | Unsaturated | Tripropylene Glycol | 5 | 35 | 5 | 15 | — | 15 |
| | Monomer | Diacrylate | | | | | | |
| | Compounds | Pentaerythritol Triacrylate | 5 | — | 5 | 7 | — | 7 |
| | | Acryloyl Morpholine | — | 35 | — | — | — | — |
| | | Isobornyl Acrylate | — | — | — | — | 20 | — |
| | | Dipentacrythritol | — | — | — | — | — | — |
| | | Pentaacrylate | | | | | | |
| | | Tetrahydrofurfuryl | — | — | — | — | — | — |
| | | Acrylate | | | | | | |
| | | 4-Hydroxybutyl Acrylate | — | — | — | — | — | — |
| | | 2-Methyl-2-ethyl-1,3- | — | — | — | — | 25 | — |
| | | dioxolane-4-ylmethyl | | | | | | |
| | | Acrylate | | | | | | |
| | | Dimethylol Tricyclodecane | — | — | — | — | 20 | — |
| | | Diacrylate | | | | | | |
| | Polymerizable | Urethane Acrylate | — | 6 | — | — | — | — |
| | Oligomer | Oligomer | | | | | | |

| | | | | | | | |
|---|---|---|---|---|---|---|---|
| Polymerization Initiators | Bis(2,4,6- | 6 | — | 6 | 5 | — | 5 |
| | trimethylbenzoyl)- | | | | | | |
| | phenylphosphine Oxide | | | | | | |
| | 2,4,6-Trimethylbenzoyl- | 5 | — | 5 | 3 | — | 3 |
| | diphenyl-phosphine Oxide | | | | | | |
| | 2,4-Diethylthioxanthone 1 | 3.5 | — | 3.5 | 3.5 | — | 3.5 |
| | 2-Isopropylthioxanthone | — | — | — | — | — | — |
| | 2,4-Diethylthioxanthone 2 | — | — | — | — | — | — |
| | 2-Benzyl-2- | — | 3.5 | — | — | — | — |
| | dimethylamino-1-(4- | | | | | | |
| | morpholinophenyl)- | | | | | | |
| | butanone-1 | | | | | | |
| | 2-Methyl-1-(4- | — | — | — | — | 4.5 | — |
| | methylthiophenyl)-2- | | | | | | |
| | morpholinopropane-1-one | | | | | | |
| Polymerization Inhibitors | p-Methoxyphenol | 0.2 | 0.2 | 0.2 | 0.2 | 0.2 | 0.2 |
| | 2,6-di-tert-Butyl-p-cresol | — | — | — | — | — | — |
| Surfactants | Polyether-modified | 0.3 | — | 0.3 | 0.3 | — | 0.3 |
| | Polydimethylsiloxane | | | | | | |
| | Acrylic-functional-group- | — | 0.3 | — | — | — | — |
| | containing Modified | | | | | | |
| | Polydimethylsiloxane 1 | | | | | | |
| | Acrylic-functional-group- | — | — | — | — | — | — |
| | containing Modified | | | | | | |
| | Polydimethylsiloxane 2 | | | | | | |
| | Crosslinkable-functional- | — | — | — | — | 0.3 | — |
| | group-containing Modified | | | | | | |
| | Polyether | | | | | | |

TABLE 5

| | | | | | | Comparative | | |
|---|---|---|---|---|---|---|---|---|
| | | | Examples | | | Examples | | |
| | | | 7 | 8 | 9 | 1 | 2 | 3 |
| Pigment Dispersions | | Types | M | L | O | J | K | N |
| | | Content | 30 | 30 | 30 | 30 | 30 | 30 |
| Polymerizable | Polymerizable | Benzyl Acrylate | 40 | 40 | 40 | 40 | 40 | 40 |
| Compounds | Unsaturated | Tripropylene Glycol | 15 | 15 | 15 | 15 | 15 | 15 |
| | Monomer | Diacrylate | | | | | | |
| | Compounds | Pentaerythritol Triacrylate | 7 | 7 | 7 | 7 | 7 | 7 |
| | | Acryloyl Morpholine | — | — | — | — | — | — |
| | | Isobornyl Acrylate | — | — | — | — | — | — |
| | | Dipentaerythritol | — | — | — | — | — | — |
| | | Pentaacrylate | | | | | | |
| | | Tetrahydrofurfuryl | — | — | — | — | — | — |
| | | Acrylate | | | | | | |
| | | 4-Hydroxybutyl Acrylate | — | — | — | — | — | — |
| | | 2-Methyl-2-ethyl-1,3- | — | — | — | — | — | — |
| | | dioxolane-4-ylmethyl | | | | | | |
| | | Acrylate | | | | | | |
| | | Dimethylol Tricyclodecane | — | — | — | — | — | — |
| | | Diacrylate | | | | | | |
| | Polymerizable | Urethane Acrylate | — | — | — | — | — | — |
| | Oligomer | Oligomer | | | | | | |

| | | | | | | | |
|---|---|---|---|---|---|---|---|
| Polymerization Initiators | Bis(2,4,6- | 5 | 5 | 5 | 5 | 5 | 5 |
| | trimethylbenzoyl)- | | | | | | |
| | phenylphosphine Oxide | | | | | | |
| | 2,4,6-Trimethylbenzoyl- | 3 | 3 | 3 | 3 | 3 | 3 |
| | diphenyl-phosphine Oxide | | | | | | |
| | 2,4-Diethylthioxanthone 1 | 3.5 | 3.5 | 3.5 | 3.5 | 3.5 | 3.5 |
| | 2-Isopropylthioxanthone | — | — | — | — | — | — |
| | 2,4-Diethylthioxanthone 2 | — | — | — | — | — | — |
| | 2-Benzyl-2- | — | — | — | — | — | — |
| | dimethylamino-1-(4- | | | | | | |
| | morpholinophenyl)- | | | | | | |
| | butanone-1 | | | | | | |
| | 2-Methyl-1-(4- | — | — | — | — | — | — |
| | methylthiophenyl)-2- | | | | | | |
| | morpholinopropane-1-one | | | | | | |
| Polymerization Inhibitors | p-Methoxyphenol | 0.2 | 0.2 | 0.2 | 0.2 | 0.2 | 0.2 |
| | 2,6-di-tert-Butyl-p-cresol | — | — | — | — | — | — |
| Surfactants | Polyether-modified | 0.3 | 0.3 | 0.3 | 0.3 | 0.3 | 0.3 |
| | Polydimethylsiloxane | | | | | | |
| | Acrylic-functional-group- | — | — | — | — | — | — |
| | containing Modified | | | | | | |
| | Polydimethylsiloxane 1 | | | | | | |
| | Acrylic-functional-group- | — | — | — | — | — | — |
| | containing Modified | | | | | | |
| | Polydimethylsiloxane 2 | | | | | | |
| | Crosslinkable-functional- | — | — | — | — | — | — |
| | group-containing Modified | | | | | | |
| | Polyether | | | | | | |

TABLE 6

| | | | | | Comparative | | |
|---|---|---|---|---|---|---|---|
| | | | Examples | | Example | Examples | |
| | | | 10 | 11 | 4 | 12 | 13 |
| Pigment Dispersions | | Types | C | E | H | D | I |
| | | Content | 30 | 30 | 30 | 30 | 30 |
| Polymerizable | Polymerizable | Benzyl Acrylate | — | — | — | — | — |
| Compounds | Unsaturated | Tripropylene Glycol | — | 5 | — | — | — |
| | Monomer | Diacrylate | | | | | |
| | Compounds | Pentaerythritol Triacrylate | — | 5 | — | — | — |
| | | Acryloyl Morpholine | 35 | — | 35 | — | — |
| | | Isobornyl Acrylate | 20 | — | 20 | — | — |
| | | Dipentaerythritol | 15 | — | 15 | — | — |
| | | Pentaacrylate | | | | | |
| | | Tetrahydrofurfuryl Acrylate | — | — | — | 57 | 57 |
| | | 4-Hydroxybutyl Acrylate | — | 45 | — | — | — |
| | | 2-Methyl-2-ethyl-1,3- | — | — | — | — | — |
| | | dioxolane-4-ylmethyl | | | | | |
| | | Acrylate | | | | | |
| | | Dimethylol Tricyclodecane | — | — | — | — | — |
| | | Diacrylate | | | | | |
| | Polymerizable | Urethane Acrylate | — | — | — | — | — |
| | Oligomer | Oligomer | | | | | |

| | | | | | | |
|---|---|---|---|---|---|---|
| Polymerization Initiators | Bis(2,4,6- | 5 | 6 | 5 | 8 | 8 |
| | trimethylbenzoyl)- | | | | | |
| | phenylphosphine Oxide | | | | | |
| | 2,4,6-Trimethylbenzoyl- | 5 | 5 | 5 | — | — |
| | diphenyl-phosphine Oxide | | | | | |
| | 2,4-Diethylthioxanthone 1 | — | 3.5 | — | — | — |
| | 2-Isopropylthioxanthone | 4.5 | — | 4.5 | — | — |
| | 2,4-Diethylthioxanthone 2 | — | — | — | 4.5 | 4.5 |
| | 2-Benzyl-2- | — | — | — | — | — |
| | dimethylamino-1-(4- | | | | | |
| | morpholinophenyl)- | | | | | |
| | butanone-1 | | | | | |
| | 2-Methyl-1-(4- | — | — | — | — | — |
| | methylthiophenyl)-2- | | | | | |
| | morpholinopropane-1-one | | | | | |
| Polymerization Inhibitors | p-Methoxyphenol | — | 0.2 | — | 0.2 | 0.2 |
| | 2,6-di-tert-Butyl-p-cresol | 0.2 | — | 0.2 | — | — |
| Surfactants | Polyether-modified | — | 0.3 | — | 0.3 | 0.3 |
| | Polydimethylsiloxane | | | | | |
| | Acrylic-functional-group- | — | — | — | — | — |
| | containing Modified | | | | | |
| | Polydimethylsiloxane 1 | | | | | |
| | Acrylic-functional-group- | 0.3 | — | 0.3 | — | — |
| | containing Modified | | | | | |
| | Polydimethylsiloxane 2 | | | | | |
| | Crosslinkable-functional- | — | — | — | — | — |
| | group-containing Modified | | | | | |
| | Polyether | | | | | |

TABLE 7

| | | Before Storage | | | After Storage at 70° C. for 2 Weeks | | | |
|---|---|---|---|---|---|---|---|---|
| | | | Non- | Ratio of | | Non- | Ratio of | Ratio of |
| | | Adsorption | Adsorption | Non- | Adsorption | Adsorption | Non- | Adsorbed |
| | | Amount of | Amount of | Adsorbed | Amount of | Amount of | Adsorbed | Dispersant |
| | | Dispersant | Dispersant | Dispersant | Dispersant | Dispersant | Dispersant | after Storage |
| | | (mg) | (mg) | (%) | (mg) | (mg) | (%) | (%) |
| Examples | 1 | 29.5 | 6.9 | 23.4 | 29.0 | 7.4 | 25.5 | 98.3 |
| | 2 | 30.4 | 6.0 | 19.7 | 28.5 | 7.9 | 27.7 | 93.8 |
| | 3 | 21.3 | 15.1 | 70.9 | 15.5 | 20.9 | 134.8 | 72.8 |
| | 4 | 24.1 | 3.1 | 12.9 | 24.5 | 2.7 | 11.0 | 101.7 |
| | 5 | 22.5 | 4.7 | 20.9 | 21.0 | 6.2 | 29.5 | 93.3 |
| | 6 | 18.5 | 8.7 | 47.0 | 17.0 | 10.2 | 60.0 | 91.9 |
| | 7 | 13.7 | 13.5 | 98.5 | 16.8 | 10.4 | 61.9 | 122.6 |
| | 8 | 12.1 | 15.1 | 124.8 | 10.5 | 16.7 | 159.0 | 86.8 |
| | 9 | 8.9 | 18.3 | 205.6 | 5.8 | 21.4 | 369.0 | 65.1 |
| | 10 | 9.5 | 8.7 | 91.6 | 8.0 | 10.2 | 127.5 | 84.2 |
| | 11 | 75.8 | 15.1 | 20.0 | 77.1 | 13.8 | 17.9 | 101.7 |
| | 12 | 38.5 | 16.0 | 41.6 | 38.3 | 15.8 | 41.3 | 99.5 |
| | 13 | 21.0 | 33.5 | 159.5 | 15.5 | 39.0 | 251.6 | 73.8 |
| Comparative | 1 | 3.8 | 41.7 | 1097.4 | 1.5 | 40.2 | 2680.0 | 39.5 |
| Examples | 2 | 95.1 | 86.7 | 91.2 | 45.2 | 136.6 | 302.2 | 47.5 |
| | 3 | 2.1 | 16.1 | 766.7 | 2.2 | 16.0 | 727.3 | 104.8 |
| | 4 | 105.3 | 31.1 | 29.5 | 98.5 | 37.9 | 38.5 | 93.5 |

The above-prepared active energy ray curable compositions 1-17, corresponding to Examples 1-13 and Comparative Examples 1-4, were subject to the evaluations of dischargeability, filterability, hiding power, curability, and adhesion property as follows. The evaluation results are described in Table 8. Table 8 also lists the volume average particle diameters and volume particle diameter distributions of the active energy ray curable compositions and the number average primary particle diameters of the pigment.

### Dischargeability

Dischargeability (i.e., discharge stability) was evaluated by a discharge test using a dischargeability tester equipped with GEN5 head available from Ricoh Co., Ltd. at 2 KHz, and graded as follows.

A: The variation in droplets was 5% or less.

B: The variation in droplets was more than 5% and not more than 10%.

C: The variation in droplets was more than 10% and not more than 20%.

D: The variation in droplets was more than 20%.

### Filterability

Filterability was evaluated by a filtration test using a filterability tester (available from Ricoh Co., Ltd.), in which 100 g of a sample (e.g., ink) was allowed to pass through a 10-μm filter at a pressure of 50 kPa, and graded as follows.

A: The ratio of the amount of filtration at the end of the test to that at the initial stage of the test was 0.8 or more.

B: The ratio of the amount of filtration at the end of the test to that at the initial stage of the test was 0.5 or more and less than 0.8.

C: The ratio of the amount of filtration at the end of the test to that at the initial stage of the test was 0.1 or more and less than 0.5.

D: Filtration was stopped during the test, or the ratio of the amount of filtration at the end of the test to that at the initial stage of the test was less than 0.1.

### Hiding Power

Each active energy ray curable composition was subject to formation of a solid image with each side having a length of 10 cm (10 cm×10 cm) on a recording medium (COSMOSHINE A4300 available from Toyobo Co., Ltd., a coated transparent PET film having an average thickness of 100 μm) using a test printer (prepared by modifying a printer SG7100 available from Ricoh Co., Ltd.). The solid image was exposed to light emitted from an UV-LED device (a single-path water-cooling UV-LED Module available from Ushio Inc.) used for inkjet printers at an illuminance of 1 W/cm² until the irradiation amount became 500 mJ/cm². Thus, the solid image was cured into an image (cured product) with each side having a length of 10 cm (10 cm×10 cm) having an average thickness of 10 μm.

The irradiation amount was measured with an ultraviolet meter (UM-10 available from Konica Minolta, Inc.) and a light receiving part (UM-400 available from Konica Minolta, Inc.). The average thickness was measured by subjecting 10 randomly selected portions of the image to a measurement by an electronic micrometer (available from Anritsu Corporation) and averaging the 10 measured values. The test printer was a modification of a printer SG7100 (available from Ricoh Co., Ltd.) in which the head had been replaced with an MH2620 head (available from Ricoh Co., Ltd.) capable of heat-discharging and applicable to high-viscosity inks while the conveying and driving parts thereof were used as they were.

The image (cured product) was subject to a measurement of a density relative to black color by a reflective spectrodensitometer (X-Rite 939 available from X-Rite) with a black paper sheet (EXTRA BLACK available from Takeo Co, Ltd., having a density of 1.65) put on the other side of the recording medium opposite to the side having the image thereon, to measure the contrast ratio. The contrast ratio was calculated from the following formula (1). The higher the contrast ratio, the higher the hiding power.

Contrast Ratio (%)=[1−(Density of Image (Cured Product)/Density of Black Paper Sheet (1.65))]×100 Formula (1)

### Curability

Each active energy ray curable composition was subject to formation of an image (cured product) with each side having a length of 10 cm (10 cm×10 cm) having an average thickness of 10 μm in the same manner as in the evaluation of hiding power. The image (cured product) was rubbed back and forth 10 times with a piece of white cotton cloth attached to a crock meter (No. 416 available from Yasuda Seiki seisakusho LTD.) at a load of 50 g/cm². After rubbing the image, the piece of white cotton cloth was subject to a measurement of density by a reflective spectrodensitometer (X-Rite 939 available from X-Rite). Curability was evaluated based on the difference between the densities of the piece of white cotton cloth before and after the rubbing of the image, and graded as follows.

A: The density difference was 0.001 or less.

B: The density difference was more than 0.001 and not more than 0.005.

C: The density difference was more than 0.005 and not more than 0.009.

D: The density difference was more than 0.009.

### Adhesion Property

Each active energy ray curable composition was subject to formation of an image (cured product) with each side having a length of 10 cm (10 cm×10 cm) having an average thickness of 10 μm in the same manner as in the evaluation of hiding power. According to JIS K5400, the solid part of the image (cured product) was cut into a grid pattern with 100 squares at an interval of 1 mm with a cutter knife, adhered to a piece of adhesive cellophane tape (SCOTCH Mending Tape (18 mm) available from 3M Japan Limited), and then peeled off from the tape. The tape was then visually observed with a loupe (PEAK No. 1961 (×10) available from Tohkai Sangyo Co., Ltd.) to count the number of squares which had not been peeled off therefrom. Adhesion property was graded as follows.

A: The number of squares which had not been peeled off from the tape was 100 out of 100 squares.

B: The number of squares which had not been peeled off from the tape was in the range of from 80 to 99 out of 100 squares.

C: The number of squares which had not been peeled off from the tape was in the range of from 40 to 79 out of 100 squares.

D: The number of squares which had not been peeled off from the tape was 39 or less out of 100 squares.

TABLE 8

| | | | Composition | | | | | | | | |
|---|---|---|---|---|---|---|---|---|---|---|---|
| | | | | Content | Content | | | | | | |
| | | | | Rate of | Rate of | | | | | | |
| | | | | Particles | Particles | | | | | | |
| | | | | having | having | | | | | | |
| | | Pigment | | Volume | Volume | | | | | | |
| | | Number | | Particle | Particle | | | | | | |
| | | Average | Volume | Diameter | Diameter | | | | | | |
| | | Primary | Average | of 170 nm | of 380 nm | | | | | | |
| | | Particle | Particle | or | or | Particle | Evaluations | | | | |
| | | Diameter | Diameter | less | more | Diameter | | | Hiding | | |
| | | (Dn) | (Dv) | (% by | (% by | Ratio | | | Power | | Adhesion |
| | | (nm) | (nm) | volume) | volume) | (Dv/Dn) | Dischargeability | Filterability | (%) | Curability | Property |
| Examples | 1 | 230 | 260 | 6.0 | 6.1 | 1.13 | A | A | 87.5 | A | A |
| | 2 | 230 | 265 | 6.1 | 6.5 | 1.15 | A | A | 87.2 | A | A |
| | 3 | 270 | 320 | 6.6 | 17.2 | 1.19 | B | B | 83.2 | B | B |
| | 4 | 230 | 265 | 8.1 | 7.9 | 1.15 | A | A | 86.5 | A | A |
| | 5 | 230 | 298 | 8.8 | 11.9 | 1.30 | A | A | 86.9 | A | A |
| | 6 | 300 | 311 | 6.1 | 21.3 | 1.04 | A | A | 83.6 | A | A |
| | 7 | 230 | 328 | 1.9 | 21.2 | 1.43 | B | B | 83.7 | A | B |
| | 8 | 230 | 301 | 8.1 | 19.2 | 1.31 | B | B | 85.0 | B | B |
| | 9 | 230 | 305 | 6.0 | 20.3 | 1.32 | B | B | 83.0 | B | B |
| | 10 | 230 | 284 | 7.9 | 8.8 | 1.23 | A | B | 83.0 | A | B |
| | 11 | 230 | 271 | 10.5 | 6.0 | 1.18 | B | B | 85.5 | A | B |
| | 12 | 250 | 278 | 6.1 | 7.9 | 1.11 | A | B | 85.0 | A | A |
| | 13 | 250 | 340 | 0.8 | 26.3 | 1.36 | B | B | 84.0 | B | B |
| Comparative | 1 | 230 | 310 | 7.5 | 12.6 | 1.35 | B | B | 77.7 | B | B |
| Examples | 2 | 290 | 378 | 0 | 41.2 | 1.30 | C | D | 83.2 | C | D |
| | 3 | 210 | 284 | 16.2 | 29.4 | 1.35 | C | B | 76.5 | B | B |
| | 4 | 210 | 239 | 19.8 | 5.5 | 1.14 | D | C | 84.5 | D | D |

It is clear from Table 8 that the active energy ray curable compositions according to some embodiments of the invention have a good combination of dischargeability, filterability, hiding power, curability, and adhesion property.

When the absorption amount of the dispersant is within the specified range, the pigment is well dispersed without causing aggregation, thus improving hiding power. In addition, dischargeability and filterability are improved because no excessive dispersant exists. Moreover, curability and adhesion property are improved because no excessive dispersant exists. Excessive dispersant may inhibit curability of the dispersant.

Even when the same materials are used, there may be either cases in which the absorption amount of the dispersant is within or beyond the specified range. The absorption amount of the dispersant within the specified range can be achieved only when the used materials, formulation, and production method are optimized.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An active energy ray curable composition comprising:
a pigment including a titanium oxide;
a dispersant; and
a polymerizable compound,
wherein at least a part of the dispersant is adsorbed to the pigment at an adsorption rate of from 5 to 80 mg per 1 g of the pigment.

2. The active energy ray curable composition of claim 1,
wherein a first amount of the dispersant is adsorbed to the pigment at an adsorption rate of from 10 to 30 mg per 1 g of the pigment, a second amount of the dispersant is not adsorbed to the pigment, and the second amount ranges from 10% to 50% of the first amount.

3. The active energy ray curable composition of claim 2, wherein, after the active energy ray curable composition has been stored at 70° C. for two weeks, a third amount of the dispersant is adsorbed to the pigment, and the third amount ranges from 80% to 120% of the first amount.

4. The active energy ray curable composition of claim 1, wherein the pigment has a number average primary particle diameter of from 220 to 260 nm.

5. The active energy ray curable composition of claim 1, wherein the dispersant includes an acrylic block copolymer having an acid value of 5 mgKOH/g or more and an amine value of 15 mgKOH/g or more.

6. The active energy ray curable composition of claim 1,
wherein the active energy ray curable composition has a volume average particle diameter of from 230 to 300 nm, and
wherein 10% by volume or less of the active energy ray curable composition has a particle diameter of 170 nm or less and another 10% by volume or less of the active energy ray curable composition has a particle diameter of 380 nm or more.

7. The active energy ray curable composition of claim 1, wherein a ratio (Dv/Dn) of a volume average particle diameter (Dv) of the active energy ray curable composition and a number average primary particle diameter (Dn) of the pigment ranges from 1 to 1.2.

8. The active energy ray curable composition of claim 1, wherein the active energy ray curable composition is sensitive to a light-emitting diode light having a light-emitting peak within a wavelength range of from 360 to 400 nm.

9. A stereoscopic modeling material comprising:
the active energy ray curable composition of claim 1.

10. An active energy ray curable ink comprising:
the active energy ray curable composition of claim 1.

11. An inkjet ink comprising:
the active energy ray curable ink of claim 10.

12. A composition storage container comprising:
a container; and
the active energy ray curable composition of claim 1 contained in the container.

13. A two-dimensional or three-dimensional image forming apparatus, comprising:
an emitter to emit an active energy ray to the active energy ray curable composition of claim 1; and
a storage to store the active energy ray curable composition.

14. The two-dimensional or three-dimensional image forming apparatus of claim 13, further comprising:
a discharger to discharge the active energy ray curable composition by an inkjet recording method.

15. A two-dimensional or three-dimensional image forming method, comprising:
emitting an active energy ray to the active energy ray curable composition of claim 1 to cause the active energy ray composition to cure.

16. The two-dimensional or three-dimensional image forming method of claim 15, further comprising:
discharging the active energy ray curable composition by an inkjet recording method.

17. The two-dimensional or three-dimensional image forming method of claim 15, wherein the active energy ray is light-emitting diode light.

18. A two-dimensional or three-dimensional image produced by a method comprising:
emitting an active energy ray to the active energy ray curable composition of claim 1 to cause the active energy ray composition to cure.

19. A structural body comprising:
a substrate; and
the two-dimensional or three-dimensional image of claim 18 on the substrate.

20. A processed product produced by a method comprising:
stretching-processing the structural body of claim 19.
